(19) United States
(12) Patent Application Publication
(10) Pub. No.: US 2011/0253919 A1
(43) Pub. Date: Oct. 20, 2011

(54) CONTROL DEVICE FOR VEHICULAR ON/OFF CONTROL VALVE

(75) Inventors: Ken Imamura, Okazaki-shi (JP); Hideki Miyata, Okazaki-shi (JP)

(73) Assignee: TOYOTA JIDOSHA KABUSHIKI KAISHA, Toyota-shi, Aichi (JP)

(21) Appl. No.: 13/141,592

(22) PCT Filed: Jan. 5, 2010
(86) PCT No.: PCT/JP2010/050190

§ 371 Date: Jun. 22, 2011

(30) Foreign Application Priority Data
Jan. 9, 2009 (JP) 2009-004128

(51) Int. Cl. F16K 31/02

(52) U.S. Cl. 251/129.15

(57) ABSTRACT

It is provided a control device for a vehicular on/off control valve used in a hydraulic control circuit of a vehicle for switching an operating state of the on/off control valve between a turn-on state or a turn-off state on electrically-magnetizing or non-electrically-magnetizing a solenoid incorporated in the on/off control valve, the control device being operable to set a current value current-supplied to the solenoid in an operation initiating current value needed for initially switching the on/off control valve from the turn-off state to the turn-on state during an electrically-magnetized state of the solenoid, and in a sustaining current value lower than the operation initiating current value and needed for sustaining the turn-on state after switched to the turn-on state.

### TECHNICAL FIELD

The present invention relates to a technology of controlling an electric current magnetizing a solenoid of an electromagnetic on/off control valve incorporated in a vehicle.

### BACKGROUND ART

An on/off control valve (such as, for instance, a three-way valve), forming one kind of an electromagnetic directional control valve and used in a vehicular hydraulic control circuit, has flow passages switched on a flow-passage switching control. With such a flow-passage switching control, a solenoid incorporated in the on/off control valve is placed in an electrically-magnetized state i.e., excited state, or a non-electrically-magnetized state, i.e., unexcited state. This allows the flow passages of the on/off control valve to be switched in line with the respective states of the solenoid. With the solenoid remained magnetized in such a flow-passage switching control, the solenoid generates an magnetic force higher than and against an urging force of a spring or the like incorporated in the on/off control valve, thereby sustaining the flow passage in line with the electrically-magnetized state of the solenoid.

The flow-passage switching control of the related art mentioned above, has been executed using a driver circuit in which the solenoid is switched to the electrically-magnetized state or the non-electrically-magnetized state in response to a turn-on or turn-off of a given voltage of a vehicular power supply, i.e., a voltage of, for instance, a vehicular battery. That is, the solenoid is sustained in the electrically-magnetized state with a current value that is uniquely determined based on the voltage (applied voltage) applied to the solenoid, and a coil resistance of the solenoid.

The solenoid generates the magnetic force (magnetomotive force) that is determined with a product of a number of coil turns of the solenoid and the current value current-supplied to the solenoid. Thus, the higher the current value is, the higher the magnetic force (magnetomotive force) becomes. Further, the higher the coil temperature of the solenoid is, the higher the coil resistance becomes, and if the voltage applied to the solenoid is fixed, then, the current value decreases with an increase in the coil resistance. If the solenoid is current-supplied, then, the coil temperature increases. Thus, the higher the ambient temperature (such as, for instance, a temperature of hydraulic oil being supplied) of the on/off control valve is, the easier the probability of increasing the coil temperature. This causes the solenoid, remaining under a continuously current-supplied state, to have coil resistance with a coil resistance value, i.e., a saturated value being increased by such an increase in the coil temperature.

For instance, a coil-resistance increasing characteristic, shown in FIG. 26 in which the higher the ambient temperature of the on/off control valve is, the higher the saturated value (saturated resistance) of the coil resistance becomes, can be obtained on experimental tests. Moreover, under a circumstance where as shown by a broken line in FIG. 27, the coil resistance is saturated depending on the ambient temperature under which the solenoid is applied with the voltage (battery voltage) from the vehicular power supply, a solenoid current characteristic, in which the higher the ambient temperature of the on/off control valve, the lower will be the current value enabling the current-supplying of the solenoid with such a voltage being applied thereto, can be obtained on experimental tests.

Consequently, based on the coil-resistance increasing characteristic shown in FIG. 26 and the solenoid current characteristic shown in FIG. 27, the solenoid and the associated driver circuit have been supposed to be placed in a usage condition with the solenoid having maximized coil resistance. Even under such a usage condition, an attempt has been made to make a design to allow the flow passage to be switched by electrically-magnetizing the solenoid so as to subsequently sustain the resulting switched state (turn-on state).

Examples of the usage condition under which the coil resistance is maximized have been supposed to include, for instance, the ambient temperature of the on-off control valve. Under a situation where the coil resistance has the maximum resistance value, more particularly, even under a condition where the coil resistance lies at a saturated resistance value at an ambient temperature (at a maximum operating temperature) under such a usage condition, an attempt has been made to design to allow the voltage of the vehicular power supply to electrically magnetize the solenoid for switching the flow passages. The flow passage witching control of the related art has been executed to current-supply the solenoid with a fixed applied voltage regardless of whether or not the coil resistance varies in a value below the saturated resistance value. That is, current-supplying the solenoid with the current value that is uniquely determined with the applied voltage and the coil resistance has resulted in placement of the solenoid in a electrically-magnetized state.

Meanwhile, a control device for controlling a drive current of a linear solenoid valve operative to adjust an output hydraulic pressure has been conventionally well known. For instance, such control device is disclosed in Patent Publication 1. The linear solenoid valve, controlled with such a control device disclosed in Patent Publication 1, has a structure to allow the linear solenoid to provide an output hydraulic pressure that varies as a parameter of the drive current. Moreover, the control device disclosed in Patent Publication 1, is arranged to perform current control so as to allow the driver current to match a drive current target value enabling the realization of a given output hydraulic target value for thereby controlling an output hydraulic pressure of the linear solenoid valve.

### [Prior Art Publications]

[Patent Publication 1] Japanese Patent Publication 11-63200
[Patent Publication 2] Japanese Patent Publication 9-280411

### DISCLOSURE OF THE INVENTION

As set forth above, in the conventional flow passage switching control for the vehicular on/off control valve, the current value of the solenoid is uniquely determined in terms of the applied voltage and the coil resistance with no effort of positively controlling a current of the solenoid. Turning on or turning off the voltage of the vehicular power supply causes the solenoid to be switched in the electrically-magnetized state or the non-electrically-magnetized state. With the control device for the linear solenoid valve disclosed in Patent Publication 1, a current control for the drive current has been conducted for regulating the output hydraulic pressure mentioned above.

In the on/off control valve with no need to continuously vary an operating state, however, it is suffice for the solenoid to be switched to the electrically-magnetized state or the non-electrically-magnetized state in the related art. That is, it has been considered that the solenoid is suffice to be switched to a turn-on state or turn-off state with no need to control a current-supplying current (drive current) of the solenoid. In addition, the current control disclosed in Patent Publication 1 is performed with an object to controlling the output hydraulic pressure upon continuously varying the operating state of the linear solenoid valve. Thus, Patent Publication 1 was lack of motivational disclosure to anticipate such an object.

Meanwhile, though unknown, it is considered that with the flow passage switching control for the on/off control valve of the related art, if the coil resistance of the solenoid does not reach the maximum resistance value (for instance, of the saturated resistance value at the highest operating temperature), the solenoid is inevitably current-supplied with a large current beyond necessity for the purpose of sustaining the switched state (turn-on state of the on/off control valve) of the flow passage under the electrically-magnetized state of the solenoid. That is, it is considered that there is a case of causing wasteful power consumption to occur. As used herein, “the case where the coil resistance of the solenoid does not reach the maximum resistance value” may include a situation where the ambient temperature of the on/off control valve lies at, for instance, a normal temperature (of, for instance, 20° C.).

The driver circuit is designed to provide a saturated resistance value at the maximum operating temperature shown in FIG. 26 such that the applied voltage of the solenoid matches a voltage capable of obtaining a required switching current value needed for the solenoid to be electrically-magnetized to perform a flow-passage changeover. As used herein, the term “required switching current value” refers to a required switching current value needed for switching the operating state of the on/off control valve from the turn-on state to the turn-off state. The applied voltage and the required switching current value for the driver circuit remain at fixed values even in presence of variation in coil resistance.

With the on/off control valve having a coil-resistance increasing characteristic shown in FIG. 26, the saturated resistance value with the ambient temperature remaining at a normal temperature is extremely smaller than the saturated resistance value at the maximum operating temperature, and the coil resistance is further low before the solenoid is current-supplied at the normal temperature. Accordingly, if the ambient temperature lies at the normal temperature, the coil resistance is extremely low. Therefore, with the flow passage switching control of the related art for the on/off control valve, the lower the coil resistance is, the remarkably higher will be the current current-supplied to the solenoid than the required switching current value, resulting in wasteful power consumption.

Further, the required sustaining current value for sustaining the operating state of the on/off control valve in the turn-on state is lower than that in which the solenoid is electrically-magnetized to mechanically actuate a valve element incorporated in the on-/off control valve. Therefore, when attempting to switch the operating state of the on/off control valve from the turn-off state to the turn-on state and subsequently sustaining the turn-on state, the wasteful power consumption further increases.

The present invention has been completed with the above view in mind and has an object to provide a control device for a vehicular on/off control valve that can reduce a current value current-supplied to a solenoid of the on/off control valve to minimize power consumption of the on/off control valve.

For achieving the above object, a first aspect of the present invention provides a control device for a vehicular on/off control valve used in a hydraulic control circuit of a vehicle for switching an operating state of the on/off control valve between a turn-on sate or a turn-off state on electrically-magnetizing, i.e., exciting, or non-electrically-magnetizing, i.e., unexciting a solenoid incorporated in the on/off control valve. The control device is operable to set a current value current-supplied, i.e., driven by current to the solenoid in an operation initiating current value needed for initially switching the on/off control valve from the turn-off state to the turn-on state during an electrically-magnetized state of the solenoid, and in a sustaining current value lower than the operation initiating current value and needed for sustaining the turn-on state after switched to the turn-on state.

In a second aspect of the present invention, a feedback control is performed to match the sustaining current value with a predetermined target sustaining current value.

In a third aspect of the present invention, the current value to be current-supplied to the solenoid is set in the operation initiating current value, until a predetermined initial current-supplying time elapses from issuance of a command for switching the on/off control valve from the turn-off state to the turn-on state, and in the sustaining current value after a lapse of the initial current-supplying time.

In a fourth aspect of the present invention, the initial current-supplying time is determined based on a temperature of a hydraulic oil supplied to the on/off control valve by referring to a pre-stored relationship.

In a fifth aspect of the present invention, the initial current-supplying time is determined to be longer as temperature of the hydraulic oil becomes lower.

In a sixth aspect of the present invention, the operation initiating current value is determined based on a pressure of the hydraulic oil supplied to the on/off control valve by referring to a pre-stored relationship.

In a seventh aspect of the present invention, the on/off control valve includes an input port to which the hydraulic oil is supplied, an output port, and a valve element actuated by the solenoid, the valve element is operative to allow the input port and the output port to communicate with each other upon current-supplying of the solenoid, and to close the input port upon non-current-supplying of the solenoid, and the operation initiating current value is determined to be low as the pressure of the hydraulic oil becomes higher.

In a eighth aspect of the present invention, the on/off control valve includes an input port to which the hydraulic oil is supplied, an output port, and a valve element actuated by the solenoid, the valve element is operative to close the input port upon current-supplying of the solenoid, and to allow the input port and the output port to communicate with each other upon non-current-supplying of the solenoid, and the operation initiating current value is determined to be higher as the pressure of hydraulic oil becomes higher.

In a ninth aspect of the present invention, a feed forward control is performed in which the sustaining current value is determined based on a output voltage of a power source and the ambient temperature of the on/off control valve by referring to a pre-stored relationship decided so as to match the sustaining current value with a predetermined target sustaining current value.

According to the present invention in the first aspect, the control device is operable to set a current value current-supplied to the solenoid in an operation initiating current value needed for initially switching the on/off control valve from the turn-off state to the turn-on state during an electrically-magnetized state of the solenoid, and in a sustaining current value lower than the operation initiating current value and needed for sustaining the turn-on state after switched to the turn-on state. This reduces the current value current-supplied to the solenoid without causing any deterioration in operation of the on/off control valve. In particular, the current value can be reduced without sacrificing mechanical response of the on/off control valve. This minimizes the power consumption of the on/off control valve to be lower than that achieved in a case where no current value is switched in such a way described above. As used herein, the term “mechanical response” refers to switching response of the on/off control valve with the operating state being switched from the turn-off state to the turn-on state when the solenoid is electrically switched from a non-electrically-magnetized state to an electrically-magnetized state.

With the present invention in the second aspect, a feedback control is performed to match the sustaining current value with a predetermined target sustaining current value. This causes the current value current-supplied to the solenoid to be stably converged with the target sustaining current value, thereby reliably sustaining the turn-on state.

With the present invention in the third aspect, the current value to be current-supplied to the solenoid is set in the operation initiating current value, until a predetermined initial current-supplying time elapses from issuance of a command for switching the on/off control valve from the turn-off state to the turn-on state, and in the sustaining current value after a lapse of the initial current-supplying time. Accordingly, determining lapse of the initial current-supplying time lowers the current value from the operation initial current value to the sustain current value, so that the power consumption in the on/off control valve can be suppressed.

With the present invention in the fourth aspect, the initial current-supplying time is determined based on a temperature of a hydraulic oil supplied to the on/off control valve by referring to a pre-stored relationship. This can ensure that the on/off control valve has appropriate mechanical response while suppressing influence of an impact resulting from the temperature of hydraulic oil.

With the present invention in the fifth aspect, the initial current-supplying time is determined to be longer as temperature of the hydraulic oil becomes lower. This can avoid the temperature of hydraulic oil from giving the impact on mechanical response of the on/off control valve. This ensures stable mechanical response of the on/off control valve.

With the present invention in the sixth aspect, the operation initiating current value is determined based on a pressure of the hydraulic oil supplied to the on/off control valve by referring to a pre-stored relationship. This can ensure that the on/off control valve has appropriate mechanical response while suppressing influence of the impact resulting from the pressure of hydraulic oil.

With the present invention in the seventh aspect, the on/off control valve includes a valve element operative to allow the input port and the output port to communicate with each other upon current-supplying of the solenoid, and to close the input port upon non-current-supplying of the solenoid, and the operation initiating current value is determined to be low as the pressure of the hydraulic oil becomes higher. Thus, the pressure of hydraulic oil supplied to the input port acts on the valve element in a direction to facilitate a movement to switch the turn-off state to the turn-on state. In this connection, the operation initiating current value is determined to be lower as the pressure of hydraulic oil becomes higher. This avoids the pressure of hydraulic oil from giving the impact on mechanical response of the on/off valve in line with the structure of the on/off control valve. As a result, the on/off control valve can be ensured to have stable mechanical response.

With the present invention in the eighth aspect, the on/off control valve includes a valve element operative to close the input port upon current-supplying of the solenoid, and to allow the input port and the output port to communicate with each other upon non-current-supplying of the solenoid, and the operation initiating current value is determined to be higher as the pressure of hydraulic oil becomes higher. Thus, the pressure of hydraulic oil supplied to the input port acts on the valve element in the direction to disturb the movement to switch the turn-off state to the turn-on state. In this connection, the operation initiating current value is determined to be higher as the pressure of hydraulic oil becomes higher. This avoids the pressure of hydraulic oil from giving an impact on mechanical response of the on/off valve in line with the structure of the on/off control valve. As a result, the on/off control valve can be ensured to have stable mechanical response.

With the present invention in the ninth aspect, a feed forward control is performed in which the sustaining current value is determined based on a output voltage of a power source and the ambient temperature of the on/off control valve by referring to a pre-stored relationship decided so as to match the sustaining current value with a predetermined target sustaining current value. Thus, an electronic control device that controls the solenoid current value by using the feed forward control is constituted more simple than an electronic control device that controls the solenoid current value by using the feedback control.

Here, preferably, the target sustaining current value is determined so as to enable the turn-on state to be sustained while minimizing the sustaining current value as low as possible when the solenoid is placed in the electrically-magnetized state. More preferably, the initial current-supplying time is the time set for temporarily increasing the current value of the solenoid for the beginning of magnetizing the solenoid with a view to improving mechanical response of the on/off control valve.

Further, the temperature of hydraulic oil supplied to the on/off control valve represents one concrete example of the ambient temperature of the on/off control valve. Thus, the initial current-supplying time may be determined based on the ambient temperature of the on/off control valve by referring to the pre-stored relationship. In addition, the initial current-supplying time may be determined to be longer as the ambient temperature of the on/off control valve becomes lower.

### BRIEF DESCRIPTION OF THE DRAWINGS

FIG. 1 is a skeleton diagram of a first embodiment for illustrating a structure of a vehicular automatic transmission controlled with an electronic control device to which the present invention is applied.

FIG. 2 is an operation engagement table of the first embodiment for illustrating operating states of frictional engagement devises to establish a plurality of gear positions in the vehicular automatic transmission shown in FIG. 1.

FIG. 3 is a block diagram for illustrating a major part of an electrical control system mounted on a vehicle for controlling the vehicular automatic transmission shown in FIG. 1, etc.

FIG. 4 is a hydraulic control circuit of the first embodiment for illustrating a major part of a hydraulic control circuit of the vehicular automatic transmission shown in FIG. 1.

FIG. 5 is a cross-sectional view illustrating a structure of a switching electromagnetic solenoid valve employed in the hydraulic control circuit to be controlled by the electronic control device to which the present invention is applied.

FIG. 6 is a cross-sectional view illustrating a structure of a switching electromagnetic solenoid valve, controlled by the electronic control device to which the present invention is applied, which can be used in the hydraulic control circuit of FIG. 4 in place of the switching electromagnetic solenoid valve shown in FIG. 5.

FIG. 7 is an electromagnetic valve driver circuit, illustrating a major part of the electromagnetic valve driver circuit for controlling an operation of the switching electromagnetic solenoid valve, which is a functional block diagram for illustrating a major part of a control function incorporated in the electronic control device to which the present invention is applied.

FIG. 8 is a timing chart of a solenoid current value for illustrating the related art on/off control, in which no current control is executed for a switching electromagnetic solenoid incorporated in the switching electromagnetic solenoid valve, shown in FIG. 5, and the switching electromagnetic solenoid is switched to an electrically-magnetized state or a non-electrically-magnetized state simply in the presence or absence of an applied voltage to the switching electromagnetic solenoid, and a solenoid control (current control) of the first embodiment in comparison to each other.

FIG. 9 is a graph showing the relationships between supplied pressures, delivered to the switching electromagnetic solenoid valve, and operation initiating current values (target operation initiating current values) for the solenoid control executed by the electronic control circuit shown in FIG. 7, for structures of the switching electromagnetic solenoid valves, respectively.

FIG. 10 is a graph showing the relationship between the supplied pressure delivered to the switching electromagnetic solenoid valve, and a sustaining current value (target sustaining current value) for the solenoid control executed by the electronic control circuit shown in FIG. 7.

FIG. 11 is a graph showing the relationship among an AT oil temperature supplied to the switching electromagnetic solenoid valve, a supplied pressure and an initial current-supplying time (on-operation current-supplying time) for the solenoid control executed by the electronic control circuit shown in FIG. 7.

FIG. 12 is a graph showing the relationship between the AT oil temperature TEMP_{OIL} and the initial current-supplying time (on-operation current-supplying time) altered from FIG. 11.

FIG. 13 is a timing chart showing how the solenoid current values are different from each other in timing charts when the initial current-supplying time, the target operation initiating current value and the target sustaining current value are determined based on the relationships shown in FIGS. 9 to 12.

FIG. 14 is a flow chart illustrating a major part of a control operation executed by the electronic control circuit shown in FIG. 7, i.e., a control operation to decrease an electrically-magnetizing current of the switching electromagnetic solenoid valve placed in an electrically-magnetized state.

FIG. 15 is a flow chart illustrating a major part of a feedback control executed at S140 in FIG. 14, i.e., a control operation to regulate a control current value of a current control element such that the sustaining current value lies at the target sustaining current value.

FIG. 16 is a block diagram of a second embodiment for illustrating a vehicular hybrid drive apparatus incorporating the electronic control device to which the present invention is applied.

FIG. 17 is a hydraulic control circuit diagram of the second embodiment, showing a major part a shifting hydraulic control circuit for automatically controlling the shifting in an automatic transmission upon engaging or disengaging various brakes of the automatic transmission incorporated in the hybrid drive apparatus shown in FIG. 16, which represents a view corresponding to FIG. 4.

FIG. 18 is an operation engagement table of the second embodiment for illustrating an operation of the hydraulic control circuit shown in FIG. 17.

FIG. 19 is a timing chart having the ordinate axis replaced by the ordinate axis of FIG. 8 and plotted with a duty ratio (current root-mean-square value) used when performing a duty control of the switching electromagnetic solenoid valve shown in FIG. 5 or FIG. 6.

FIG. 20 is a functional block diagram for illustrating a major part of a control function incorporated in the electronic control device of the third embodiment, which is an electromagnetic valve driver circuit, illustrating a major part of the electromagnetic valve driver circuit for controlling an operation of the switching electromagnetic solenoid valve shown in FIG. 5. The functional block diagram corresponds to that of FIG. 7.

FIG. 21 is a graph showing that how the solenoid current values of the switching electromagnetic solenoid valve are changed by the ambient temperature of the switching electromagnetic solenoid valve, the voltage of the solenoid power source and the duty ratio of the solenoid current.

FIG. 22 shows a relationship between the ambient temperature of the switching electromagnetic solenoid valve, the voltage of the solenoid power source and the duty ratio of the solenoid current, which is stored in the map memory means of FIG. 20.

FIG. 23 shows a table indicating the relationship of FIG. 22, which is used for determining a duty ratio of the solenoid current based on the ambient temperature of the switching electromagnetic solenoid valve, and the voltage of the solenoid power source.

FIG. 24 is a flow chart illustrating a major part of a control operation executed by the electronic control circuit shown in FIG. 20, i.e., a control operation to decrease an electrically-magnetizing current of the switching electromagnetic solenoid valve placed in an electrically-magnetized state, which shows only a different step from the flow chart shown in FIG. 14.

FIG. 25 is a flow chart illustrating a major part of a feed forward control executed at S340 in FIG. 24, i.e., a control operation to regulate a control current value of a current control element such that the duty value is determined to keep the sustaining current value at the target sustaining current value.

FIG. 26 is a view showing a coil-resistance increasing characteristic of an electromagnetic type on/off control valve in which the higher the ambient temperature is, the higher the saturated value (saturated resistance) of the coil resistance becomes.

FIG. 27 is a view in which a current-supplying amount of the coil is overlapped on the coil-resistance increasing characteristic, shown in FIG. 26, under a situation where a battery voltage is applied to the oil of the on/off control valve.

### EXPLANATION OF REFERENCES

8, 508: vehicle
90, 544, 630: electronic control device (control device)
100: hydraulic control circuit
102, 298: switching electromagnetic solenoid (solenoid)
104, 296: switching electromagnetic solenoid valve (on/off control valve)
250: input port
252: output port
262, 310: spherical valve element (valve element)
550: shifting hydraulic control circuit (hydraulic control circuit)

### BEST MODE FOR CARRYING OUT THE INVENTION

Hereunder, various embodiments of the present invention will be described below in detail with reference to the accompanying drawings.

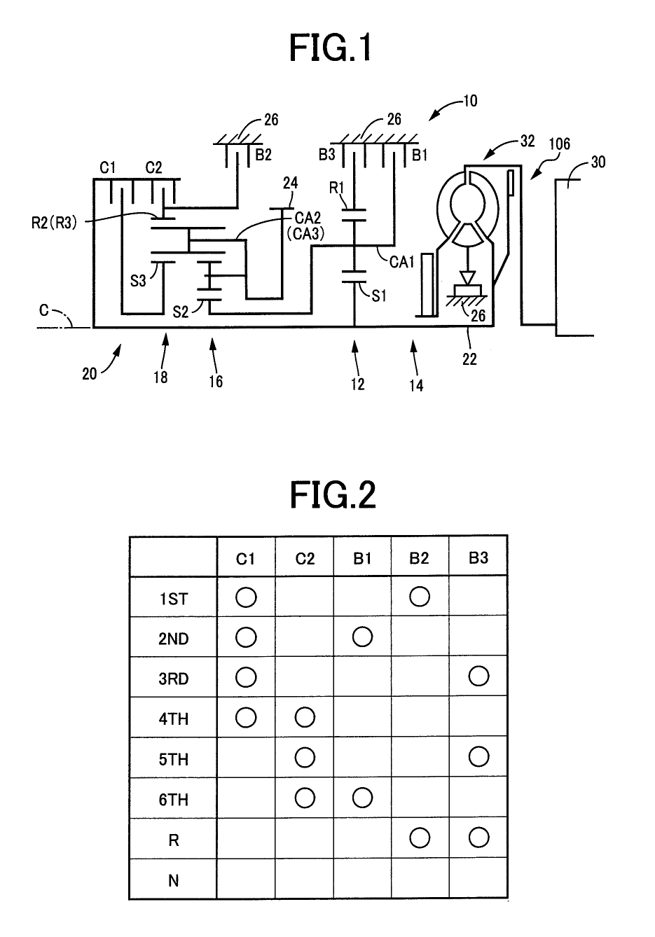

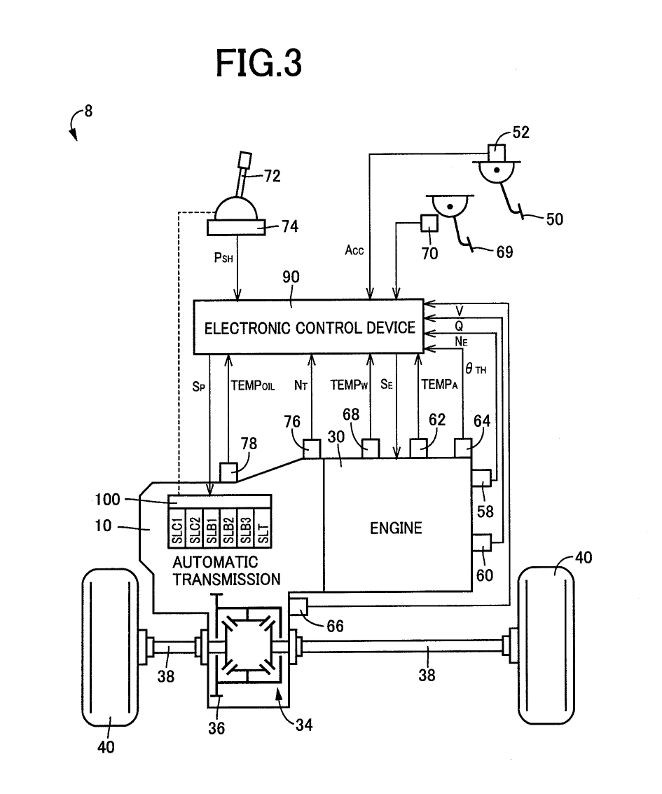

The present invention is applied to an electronic control device 90 for controlling, for instance, a vehicular automatic transmission 10. FIG. 1 is a skeleton view illustrating a structure of the vehicular automatic transmission 10 (hereinafter referred to as “automatic transmission 10”). FIG. 2 is an engagement operation table illustrating various operating states of friction engaging elements, i.e., friction engaging devices for a plurality of gear positions is established in the automatic transmission 10. The automatic transmission 10 is suitably applied to an FF vehicle in which the automatic transmission 10 is installed on a vehicle 8 (see FIG. 3) in a left and right direction (in a transversely mounted). A transmission case 26, mounted on a vehicle body and serving as a non-rotary member, incorporates therein a first shift portion 14 mainly composed of a first planetary gear set 12 of a single pinion type, and a second shifting portion 20 mainly composed of a planetary gear set 16 of a double pinion type and a third planetary gear set 18 of a single pinion type formed in a Ravigneaux type. These component parts are placed on a coaxial relation (on a common axis C), upon which a rotation of an input shaft 22 is output from an output rotary member 24 in a shifting state.

The input shaft 22 corresponds to an input member of the transmission 10 and, with the present embodiment, includes a turbine shaft of a torque converter 32 acting as a hydrodynamic power-transmitting device driven with an engine 30 acting as a drive power source for running the vehicle. The output rotation member 24, corresponding to an output of the automatic transmission 10, functions as an output gear i.e., a differential drive gear in meshing with a differential driven gear (large diameter gear) 36 of a differential gear unit 34 shown in FIG. 3 for transmitting a drive power thereto. An output of the engine 30 is transmitted to a pair of drive wheels 40 via the torque converter 32, the automatic transmission 10, the differential gear unit 34 and a pair of axles 38. Incidentally, the automatic transmission 10 and the torque converter 32 are formed in a structure having a nearly symmetric relation with respect to the center axis C (axis) and a lower half is omitted in the skeleton view of FIG. 1.

The automatic transmission 10 establishes gear positions depending on combinations in connecting states of either component parts of rotary elements (sun gears S1 to S3, carriers CA1 to CA3, and ring gears R1 to R3) of the first and second shifting portions 14 and 20. Thus, one of six forward-drive gear positions (forward-drive gear positions and forward-running gear positions), involving a 1st-speed shift position (1st-speed gear position) “1-st” to a 6th-speed shift position (6th-speed gear position) “6-th”, established and one reverse-drive gear position of a rear-drive shift position (rear-drive gear position and rear-drive running gear position) “R”.

As shown in FIG. 2, for the forward-drive gear position, engaging a first clutch C1 and a second brake B2 allows the 1st-speed gear position to be established. Engaging the first clutch C1 and a first brake B1 allows the 2nd-speed gear position to be established. Engaging the first clutch C1 and a third brake B3 allows the 3rd-speed gear position to be established. Engaging the first and second clutches C1 and C2 allows the 4th-speed gear position to be established. Engaging the second clutch C2 and a third brake B3 allows the 5th-speed gear position to be established. Engaging the second clutch C2 and the first brake B1 allows the 6th-speed gear position to be established. Moreover, engaging the second and third brakes B2 and B3 allows the reverse-drive gear position to be established. A neutral state is established upon disengagements of both the first and second clutches C1 and C2 and disengagements of both the first to third brakes B1 to B3.

The engagement operation table, shown in FIG. 2, represents the relationships among the various gear positions and the clutches C1 and C2 and the brakes B1 to B3 in which a symbol “O” refers to the clutches and the brakes being engaged. In addition, speed ratios for the various gear positions are determined depending on various gear ratios (the number of teeth of a sun gear versus the number of teeth of a ring gear) ρ1, ρ2 and ρ3 of the first planetary gear unit 12, the second planetary gear unit 16 and the third planetary gear unit 18.

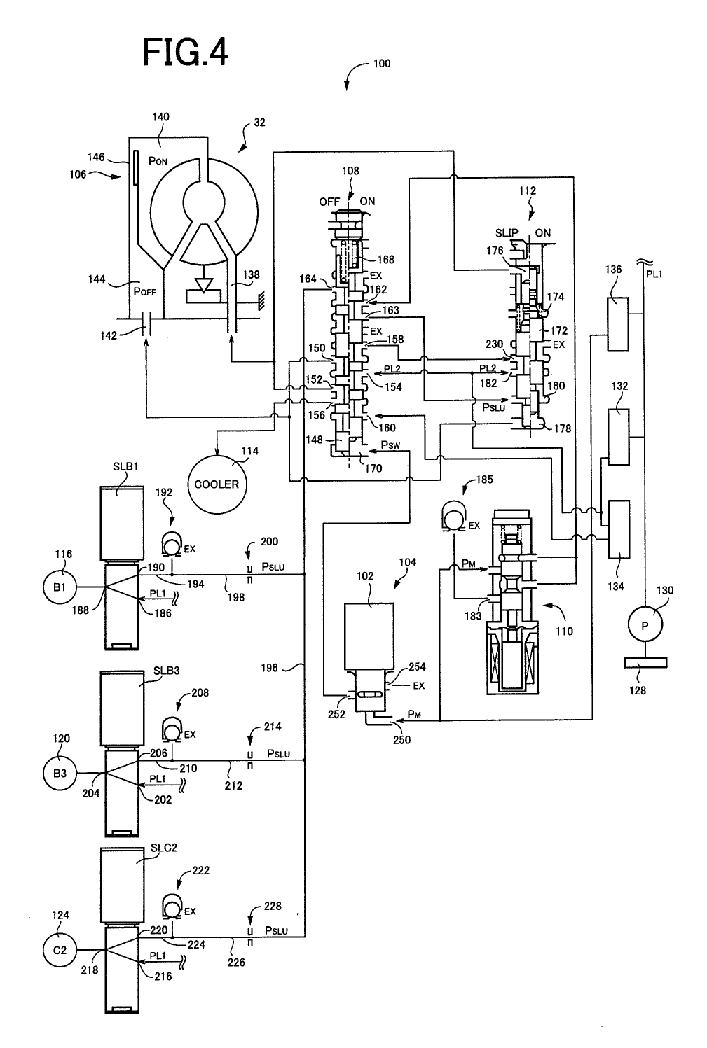

The clutches C1 and C2 and the brakes B1 to B3 (hereinafter referred to merely as a clutch C and a brake B unless otherwise specified) include hydraulic type frictional engagement devices such as multi-disc type clutches and brakes that are controllably engaged with hydraulically operated actuators. A hydraulic control circuit 100 (see FIG. 4), acting as a hydraulic control device, includes electromagnetic valve devices such as linear solenoid valves SLC1, SLC2, SLB1, SLB2 and SLB3, which are electrically-magnetized and non-electrically-magnetized and subjected to current control, upon which an engaged state and a disengaged state are switched while transient hydraulic pressures or the like are controlled during the disengagement.

FIG. 3 is a block diagram illustrating a major part of an electric control system, provided in a vehicle for controlling the automatic transmission 10 or the like shown in FIG. 1. The electronic control unit 90 takes the form of a structure including a so-called microcomputer provided with, for example, CPU, RAM, ROM and input/output interface. The CPU is arranged to perform signal processing in accordance with programs pre-stored in ROM while utilizing a temporary memory function of RAM, thereby controlling an output of the engine 30 while controlling the shifting of the automatic transmission 10 and the like. The electronic control unit 90 is structured to operate categories grouped for performing engine controls and shifting controls or the like for controlling the linear solenoid valves SLC1, SLC2, SLB1, SLB2 and SLB3 depending on needs.

As shown in FIG. 3, there are various sensors including: an accelerator depression-stroke sensor 52 for detecting a depressed stroke Acc of an accelerator pedal 50 known as a so-called accelerator-opening; an engine rotation speed sensor 58 for detecting a rotation speed N_{E} of the engine 30; a sensor 60 for detecting a quantity Q of intake air drawn into the engine 30; an intake-air temperature sensor 62 for detecting a temperature TEMP_{A} of intake air; a throttle valve opening sensor 64 for detecting an opening θ_{TH} of an electronic throttle valve; a vehicle speed sensor 66 for detecting a vehicle speed V (corresponding to a rotation speed NOUT of the output rotation member 24); a cooling water temperature sensor 68 for detecting a temperature TEMP_{W} of cooling water of the engine 30; a brake switch 70 for detecting the presence or absence of operation of a foot brake-pedal 69 acting as a usually operated pedal; a lever position sensor 74 for detecting a lever position (operated position) P_{SH} of a shift lever 72 acting as a shift operating member; a turbine rotation-speed sensor 76 for detecting a turbine rotation speed N_{T}, i.e., a rotation speed N_{IN} of an input shaft 22; and an AT oil temperature sensor 78 for detecting an AT oil temperature TEMP_{OIL} representing a temperature (hydraulic oil temperature) of hydraulic oil in the hydraulic control circuit 100, etc.

The electronic control unit 90 is connected to these sensors and switches to receive various signals including: the accelerator's depression-stroke (accelerator-opening) Acc; the engine rotation speed N_{E}; the intake air quantity Q; the intake air temperature TEMP_{A}; the throttle opening θ_{TH}; the vehicle speed V; the output rotation speed NOUT; the engine cooling water temperature TEMP_{W}; the presence or absence of braking operation; the lever position P_{SH} of the shift lever 72; the turbine rotation speed N_{T} (=input shaft rotation speed N_{IN}); and the AT oil temperature TEMP_{OIL}, etc.

Further, the electronic control unit 90 outputs engine output control command signals S_{E}, performing output control of the engine 30, which include: a signal for driving a throttle actuator for controlling opening and closing of an electronic control valve depending on, for instance, the accelerator-opening A_{cc}; an injection signal for controlling a quantity of fuel injected from a fuel injection device; and an ignition timing signal applied to the fuel ignition device for controlling ignition timing of the engine 30. Further, the electronic control unit 90 outputs shift control command signals S_{P} for performing shifting control of the automatic transmission 10, i.e., for instance, signals for controlling the linear solenoid valves SLC1, SLC2, SLB1, SLB2 and SLB3 provided in the hydraulic control circuit 100 for switching the gear position of the automatic transmission 10, and a signal for driving the linear solenoid valve SLT acting as the electromagnetic solenoid valve device for controlling a line hydraulic pressure P_{L1}.

FIG. 4 is a hydraulic control circuit diagram for illustrating a major part of a hydraulic control circuit 100 of the automatic transmission 10. With the automatic transmission 10, a given gear position is established in response to clutch-to-clutch shifting. As shown in FIG. 2, more particularly, for shifting from the 1st-speed to 2nd-speed gear position, the brake B1 is caused to engage with the brake B2 being disengaged. For shifting from the 2nd-speed to 3rd-speed gear position, the brake B3 is caused to engage with the brake B1 being disengaged. For shifting from the 3rd-speed to 4th-speed gear position, the clutch C2 is caused to engage with the brake B3 being disengaged. For shifting from the 4th-speed to 5th-speed gear position, the brake B3 is caused engage with the clutch C1 being disengaged. For shifting from the 5th-speed to 6th-speed gear position, the brake B3 is caused to engage with the brake B3 being disengaged. This allows the clutch C2, the brakes B1 and B3 to act as the frictional engaging device in the automatic transmission 10 during clutch-to-clutch upshifting. Further, although the clutch C1 and the brake B2 are omitted in FIG. 4, these component will function when performing respective shifting.

The hydraulic control circuit 100 includes: a switching electromagnetic solenoid valve 104 operative to be turned on and off by a switching electromagnetic solenoid 102 to generate a switching signal pressure P_{SW}; a clutch switching valve 108 operative to switch a lockup clutch 106 in a disengaging position (turn-off side position) to be placed in a disengaged state and an engaging position (turn-on side position) to be placed in an engaged state (turn-on side position) in accordance with the switching signal pressure P_{SW}; and a slip-control solenoid valve 110 for outputting a signal pressure P_{SLU} corresponding to a drive current supplied from the electronic control device 90.

Further, the hydraulic control circuit 100 includes: a lockup control valve 112 operative to switch an operating state of the lockup clutch 106 in a range between a slipping state and a lockup state when the clutch switching valve 108 places the lockup clutch 106 in an engaged state; an oil cooler 114 for cooling hydraulic oil; a linear solenoid valve SLB1 for feeding hydraulic oil to or discharging hydraulic oil from the friction engaging device 115 of the brake B1; an oil cooler 114 for cooling hydraulic oil; a linear solenoid valve SLB3 for feeding hydraulic oil to or discharging hydraulic oil from the friction engaging device 120 of the brake B3; and a linear solenoid valve SLC2 for feeding hydraulic oil to or discharging hydraulic oil from the friction engaging device 124 of the clutch C2.

The hydraulic control circuit 100 incorporates therein a pump 130, driven by, for instance, by the engine 30 in order to draw hydraulic oil from an oil pan (not shown) to which hydraulic oil is circulated via a strainer 128. A first regulator valve 132 of a relief type regulates a pressure of hydraulic oil, boosted by the pump 130, to a first line pressure PL1. Likewise, a second regulator valve 134 is composed of a regulator valve of a relief type and regulates the pressure of hydraulic oil flown out of the first regulator valve 132 to generate a second line pressure PL2. A third regulator valve 136, composed of a pressure reduction valve applied with the first line pressure PL1 as an original pressure, generates a modulator pressure P_{M} that is a predetermined fixed pressure. In addition, the first and second regulator valves 132 and 234 are applied with signal pressures delivered from linear solenoid valves (not shown) to regulate the line pressures at levels suited for the vehicle to run based on the accelerator-opening or the engine rotation speed of the engine 30, etc.

The lockup clutch 106 is a hydraulic friction clutch arranged to be brought into frictional engagement with a front cover 146 in response to a differential pressure ΔP (=P_{ON}-P_{OFF}) between an oil-chamber pressure P_{ON} applied to an engaging oil chamber 140 via an engaging oil passage 138, and a hydraulic pressure P_{OFF} applied to a disengaging oil chamber 144 via an disengaging oil chamber 144 via a disengaging oil passage 142. The torque converter 32 has operating conditions broadly classified into, for instance, a so-called unlock state with the lockup clutch 106 being unlocked in response to the differential pressure ΔP placed to be negative, a so-called slipping state with the lockup clutch 106 being half engaged in response to the differential pressure ΔP placed to be more than zero; and a so-called lockup on state with the lockup clutch 106 being completely locked in response to the differential pressure ΔP placed to be maximized. During the slipping state of the lockup clutch 106, further, zeroing the differential pressure ΔP results in a reduction in torque share of the lockup clutch 106 such that the torque converter 32 is placed in an operating state equivalent to the unlock state.

The clutch switching valve 108, operative to switch the lockup clutch 106 in an engaged state and a disengaged state, includes a spool valve element 148 for switching connecting states. In FIG. 4, further, a left-hand side of a centerline represents a status under which the spool valve element 148 is located in a turn-off position (OFF) with the lockup clutch 106 placed under the disengaged state, and a right-hand side of the centerline represents another status under which the spool valve element 148 is located in a turn-on position (ON) with the lockup clutch 106 placed under the engaged state. The clutch switching valve 108 further includes: an disengaging port 150 held in fluid communication with the disengaging oil chamber 144; an engaging port 152 held in fluid communication with the engaging oil chamber 140; an input port 154 to which the second line pressure PL2 is applied; a discharge port 156 through which hydraulic oil is discharged from the engaging oil chamber 140 during disengaging operation of the lockup clutch 106 and through which hydraulic oil, delivered from the second regulator valve 134, is discharged during engaging operation of the lockup clutch 106; and a circumventing port 158 through which hydraulic oil is discharged from the disengaging oil chamber 144 during the engaging operation of the lockup clutch 106.

The clutch switching valve 108 further includes: a relief port 160 to which hydraulic oil, flowed from the second regulator valve 134, is supplied; a signal pressure input port 162 to which the signal pressure P_{SLU} is applied from the throttle control solenoid valve 110; a first signal pressure output port 163 operative to allow the signal pressure P_{SLU} to be output from the signal pressure input port 162 during the engaging operation of the lockup clutch 106; a second signal pressure output port 164 to which a signal pressure P_{SLU} from the signal pressure input port 162 during the releasing i.e., disengaging operation of the lockup clutch 106 is outputted; a spring 168 for urging the spool valve element 148 toward the turn-off position; and an oil chamber 170 operative to allow a switching signal pressure P_{SW}, applied from the switching electromagnetic solenoid valve 104, to act on the spool valve element 148.

The lockup control valve 112 includes: a spool valve element 172; a spring 174 giving a thrust force to urge the spool valve element 172 toward a slip-side (SLIP) position; an oil chamber 176 applied with an hydraulic pressure P_{ON} from the engaging oil chamber 140 of the torque converter 32 for urging the spool valve element 172 toward the slip position; an oil chamber 178 applied with an hydraulic pressure P_{OFF} from the disengaging oil chamber 144 of the torque converter 32 for urging the spool valve element 172 toward a completely engaged (ON) position; an oil chamber 180 applied with the signal pressure P_{SLU} output from the first signal pressure output port 163 of the clutch switching valve 108; and an input port 182 applied with the second line pressure PL2 regulated by the second regulator valve 134. In FIG. 4, a left-hand side of a centerline shows a status under which the spool valve element 172 is positioned in the slip (SLIP) position and a right-hand side of the centerline shows another status under which the spool valve element 172 is positioned in the completely engaged (turn-on state) position.

The slip control valve 110 outputs the signal pressure P_{SLU} for controlling an engaging pressure of the lockup clutch 106 during the engaging operation of the lockup clutch 106. Further, the slip control valve 110 supplies hydraulic oil to drain circuits of the linear solenoid valve SLB1, the linear solenoid valve SLB3 and the linear solenoid valve SLC2. The slip control valve 110 is a valve, to which the fixed modulator pressure P_{M} regulated by the third regulator valve 136 is applied, which reduces the fixed modulator pressure P_{M} to output the signal pressure P_{SLU}, which is generated in proportion to the drive current applied form the electronic control device 90. Furthermore, the slip control valve 110 has a drain port 183 held in fluid communication with a check ball 185. Thus, the drain port 183 is shut off with the check ball 185 at all times and opened in response to a pressure applied to the check ball 185 at a level exceeding a given level for thereby discharging hydraulic oil.

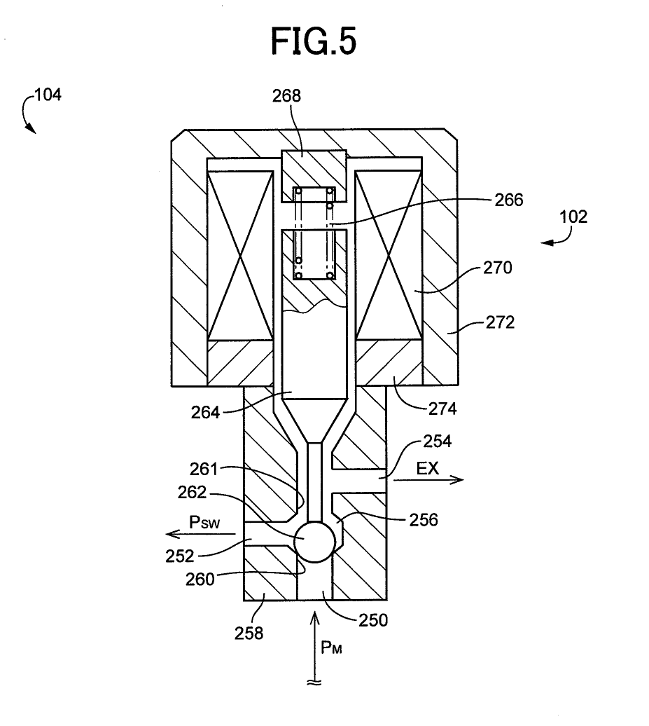

The switching electromagnetic solenoid valve 104 has an input port 250 to which the modulator pressure P_{M} is supplied, an output port 252 connected to the oil chamber 170 of the clutch switching valve 108, and a discharge port 254 through which hydraulic oil is discharged. The switching electromagnetic solenoid valve 104 allows the switching signal pressure P_{SW} to be a drain pressure under a non-electrically-magnetized state (turn-off state). Under an electrically-magnetized state (turn-on state), the switching signal pressure P_{SW} is caused to be the modulator pressure P_{M}, which acts on the oil chamber 170 to move the spool valve element 148 of the clutch switching valve 108 toward the turn-on position (ON) under the engaged state. In addition, the switching electromagnetic solenoid valve 104 corresponds to an on/off control valve of the present invention. Moreover, the structure of the switching electromagnetic solenoid valve 104 will be described below in detail with reference to FIG. 5.

The linear solenoid valve SLB1 is a regulator valve for supplying hydraulic oil to or discharging the same from the friction engaging device 116 forming the brake B1. The linear solenoid valve SLB1 has an input port 186 to which the first line pressure PL1 is applied, an output port 188 from which a hydraulic pressure is output to the friction engaging device 116, and a drain port 190 from which hydraulic oil is discharged. With the linear solenoid valve SLB1 electrically-magnetized or non-electrically-magnetized with the electronic control device 90, the linear solenoid valve SLB1 controllably regulates the first line pressure PL1 regulated with the first regulator valve 132 as the original pressure. A drain circuit 194 communicates with the drain port 190, serving as a starting point, and further communicates with an oil pan (not shown) via a check ball 192, which blocks the drain circuit 194 at all times. Upon receipt of a hydraulic pressure beyond a given pressure level, the check ball 192 is opened to discharge hydraulic oil. Further, the drain circuit 194 is connected to a first branch oil passage 198, bifurcated from a hydraulic oil supply passage 196 communicating with a second signal pressure output port 164 of the clutch switching valve 108, which has an orifice 200. The check ball 192 has an upstream side to which the slip-control solenoid valve 110 is connected via the clutch switching valve 108 and the orifice 200.

The linear solenoid valve SLB3, serving as a regulator valve for supplying hydraulic oil to and discharging the same from the frictional engaging device 120 forming the brake B3, has an input port 202 to which the first line pressure PL1 is applied, an output port 204 from which a hydraulic pressure is output to the friction engaging device 120, and a drain port 206 through which hydraulic oil is discharged. With the linear solenoid valve SLB3 electrically-magnetized or non-electrically-magnetized with the electronic control device 90, the linear solenoid valve SLB3 controllably regulates the first line pressure PL1 regulated with the first regulator valve 132 as the original pressure. A drain circuit 210 communicates with the drain port 206, serving as a starting point, and further communicates with the oil pan (not shown) via a check ball 208, which blocks the drain circuit 210 at all times. Upon receipt of the hydraulic pressure beyond a given pressure level, the check ball 208 is opened to discharge hydraulic oil.

Further, the drain circuit 210 is connected to a second branch oil passage 212, bifurcated from the hydraulic oil supply passage 196 communicating with the second signal pressure output port 164 of the clutch switching valve 108, which has an orifice 214. The check ball 208 has an upstream side to which the slip-control solenoid valve 110 is connected via the clutch switching valve 108 and the orifice 214.

The linear solenoid valve SLC2, serving as a regulator valve for supplying hydraulic oil to and discharging the same from the frictional engaging device 124 forming the clutch C2, has an input port 216 to which the first line pressure PL1 is applied, an output port 218 from which a hydraulic pressure is output to the friction engaging device 124, and a drain port 220 from which hydraulic oil is discharged. With the linear solenoid valve SLC2 electrically-magnetized or non-electrically-magnetized with the electronic control device 90, the linear solenoid valve SLC2 controllably regulates the first line pressure PL1 regulated with the first regulator valve 132 as the original pressure. A drain circuit 224 communicates with the drain port 220, serving as a starting point, and further communicates with the oil pan (not shown) via a check ball 222. Upon receipt of the hydraulic pressure beyond a given pressure level, the check ball 222 is opened to discharge hydraulic oil. Further, the drain circuit 224 is connected to a third branch oil passage 226, bifurcated from the hydraulic oil supply passage 196 communicating with the second signal pressure output port 164 of the clutch switching valve 108, which has an orifice 228. The check ball 222 has an upstream side to which the slip-control solenoid valve 110 is connected via the clutch switching valve 108 and the orifice 228.

With the hydraulic control circuit 100 of such a structure, supply states of hydraulic oil to the engaging oil chamber 140 and the disengaging oil chamber 144 are switched to switch an operating state of the lockup clutch 106 or hydraulic oil is supplied to the brakes B1 and B2 and the clutch C2 for controlling engaging pressures of these component parts.

First, description will be provided of a case in which the lockup clutch 106 is placed in a slipping state and a lockup on state. Upon operation of the switching electromagnetic solenoid valve 104, the switching signal pressure P_{SW} is supplied to the oil chamber 170 of the clutch switching valve 108. This urges the spool valve element 148, which is consequently moved toward a turn-on position. Then, the second line pressure PL2, supplied to the input port 154, is admitted from the engaging port 152 to pass to the engaging oil passage 138 to be supplied to the engaging oil chamber 140. The second line pressure PL2, supplied to the engaging oil chamber 140, serves as a hydraulic pressure P_{ON}. At the same time, the disengaging oil chamber 144 is brought into communication with a control port 230 of the lockup control valve 112 through the disengaging oil passage 142 and the disengaging port 150 communicating with the circumventing port 158. This allows the lockup control valve 112 to regulate the hydraulic pressure P_{OFF} in the disengaging oil chamber 144. That is, the lockup control valve 112 regulates the differential pressure ΔP, i.e., the engaging pressure to cause the operating state of the lockup clutch 106 to be switched in a range from the slipping state to the lockup on state.

More particularly, when the spool valve element 148 of the clutch switching valve 108 is urged toward the engaging (ON) position, i.e., when the lockup clutch 106 is switched to the engaged state, the lockup control valve 112 prevents the signal pressure P_{SLU}, for urging the spool valve element 172 to the completely engaged (ON) position, from being supplied to the oil chamber 180. This allows a thrust force of the spring 174 to move the spool valve element 172 toward the slipping (SLIP) position, in which the second line pressure PL2, supplied to the input port 182, is admitted from the control 230 to the circumventing port 158 to pass from the disengaging port 150 to the disengaging oil passage 142 to be supplied to the disengaging oil chamber 144. Under such a state, the differential pressure ΔP is controlled in response to the signal pressure P_{SLU} for thereby controlling the slipping state of the lockup clutch 106. In addition, the clutch switching valve 108 allows the signal pressure input port 162 and the first signal pressure output port 163 to be brought into communication with each other only when the spool valve element 148 is urged toward the engaging (ON) position. Thus, the slip-control solenoid valve 110 can supply the signal pressure P_{SLU} to the oil chamber 180 of the lockup control valve 112.

With the spool valve element 148 of the clutch control valve 108 urged toward the ON-position, further, the signal pressure P_{SLU} is supplied to the oil chamber 180 for urging the spool valve element 172 toward a completely engaged (ON) position and the lockup control valve 112 operates as described below. That is, no line pressure PL2 is supplied from the input port 182 to the disengaging oil chamber 144 and hydraulic oil is discharged from the disengaging oil chamber 144 via the drain port. This allows the differential pressure ΔP to be maximized such that the lockup clutch 106 is brought into a completely engaged state.

With the lockup clutch 106 placed in the slipping state or the completely engaged state, furthermore, the clutch switching valve 108 assumes the ON-position to cause the relief port 160 and the discharge port 156 to be brought into communication with each other. This allows hydraulic oil, flown out of the second regulator valve 134, to be supplied to the oil cooler 114 via the discharge port 156.

Meanwhile, with no switching signal pressure P_{SW} supplied to the oil chamber 170, the spool valve element 148 is toward the OFF-position due to an urging force of the spring 168. Then, the clutch switching valve 108 allows the second line pressure PL2, supplied to the input port 154, to pass from the disengaging port 150 into the disengaging oil passage 142 to be supplied into the disengaging oil chamber 144. Subsequently, hydraulic oil, discharged from the engaging oil chamber 140 to pass through the engaging oil passage 138 to the engaging port 152, is fed from the discharge port 156 to the oil cooler 114 for cooling.

With the clutch switching valve 108 placed in the OFF-position, moreover, the signal pressure input port 162, to which the signal pressure P_{SLU} is output from the slip-control solenoid valve 110, and the second signal pressure output port 164 are brought into communication with each other. The second signal pressure output port 164 is connected to the hydraulic oil supply passage 196, as set forth above, through which hydraulic oil delivered from the slip-control solenoid valve 110 can be supplied to the first, second and third branch oil passages 198, 212 and 226.

The structure of the switching electromagnetic solenoid valve 104, corresponding to the on/off control valve of the present invention, will be described below in detail. FIG. 5 is a cross-sectional view for illustrating the structure of the switching electromagnetic solenoid valve 104. The switching electromagnetic solenoid valve 104 is a well-known three-way valve of a normally closed type.

More particularly, the switching electromagnetic solenoid valve 104 includes: a main body member 258 made of non-magnetic material formed with the input port 250, the output port 252, the discharge port 254 and a valve chamber 256 connected to the various ports 250, 252 and 254; a spherical valve element 262 accommodated in the valve chamber 256 and having a diameter greater than an input-port-side opening aperture 260 and a discharge-port-side opening aperture 261; a plunger 264; a spring 266; and the switching electromagnetic solenoid 102, all of which have the same axes as the center axis of the input port 250. The switching electromagnetic solenoid 102 is comprised of a core 268, a cylindrical coil 270 and a bottomed cylindrical yoke 272, all of which have the same axes as the center axis mentioned above, and a magnetic body lid 274 fixedly secured to an end of the main body member 258 in opposition to the input port 256. The input port 250, the spherical valve element 262, the plunger 264, the spring 266 and the core 268 are placed in such an order along the center axis of the input port 250. In the valve chamber 256, the input-port-side opening aperture 260 and the discharge-port-side opening aperture 261 are placed in opposition to each other along the above-described center axis with the spherical valve element 262 being sandwiched therebetween.

With the yoke 272 having an open end portion plugged with the magnetic body lid 274 which is fixedly secured to the open end portion of the yoke 272, the yoke 272 and the magnetic body lid 274 constitute a housing body of the switching electromagnetic solenoid 102, within which the coil 270 and the core 268 are fixedly secured to the yoke 272. The plunger 264 has one end facing the spherical valve element 262 and the other end facing the core 268 in an area inside the coil 270. The plunger 264 is urged toward the input port 250 along the above-mentioned center axis by the spring 266 disposed between the plunger 264 and the core 268.

With the switching electromagnetic solenoid 102 (coil 270) remained under a non-electrically-magnetized state, the switching electromagnetic solenoid valve 104 has an operating state (mechanically operating state) placed under a turn-off state corresponding to the non-electrically-magnetized state. FIG. 5 shows such a turn-off state. With the switching electromagnetic solenoid valve 104 remained under the turn-off state, more particularly, the plunger 264 presses the spherical valve element 262 against the input-port-side opening aperture 260 due to the urging force of the spring 266, thereby causing the spherical valve element 262 to block the input-port-side opening aperture 260. At the same time, the output port 252 and the discharge port 254 are brought into communication with each other, causing the switching signal pressure P_{SW} in the output port 252 to be a drain pressure.

On the contrary, with the switching electromagnetic solenoid 102 (coil 270) operated under an electrically-magnetized state, the operating state of the switching electromagnetic solenoid valve 104 is placed under the turn-on state corresponding to the electrically-magnetized state. With the switching electromagnetic solenoid valve 104 operated under the turn-on state, the plunger 264 is attracted toward the core 268 due to a magnetic force generated by the coil 270 acting against and higher than that of the urging force of the spring 266. Thus, the spherical valve element 262 blocks the discharge-port-side opening aperture 261. Then, the modulator pressure P_{M} is admitted to the input port 250 to cause the spherical valve element 262 to be pressed against the discharge-port-side opening aperture 261 due to the modulator pressure P_{M} to block the discharge-port-side opening aperture 261. At the same time, the input port 250 and the output port 252 are brought into communication with each other to allow the switching signal pressure P_{SW} in the output port 252 to be the modulator pressure P_{M}.

Thus, the switching electromagnetic solenoid valve 104 takes the form of a structure wherein the spherical valve element 262, actuated with the switching electromagnetic solenoid 102, allows the input port 250 and the output port 252 to communicate with each other on current-supplying the switching electromagnetic solenoid 102 whereas non-current-supplying the switching electromagnetic solenoid 102 causes the spherical valve element 262 to block the input port 250. In addition, the switching electromagnetic solenoid 102 corresponds to a solenoid of the present invention. With the present embodiment, moreover, although the spherical valve element 262 corresponds to a valve element of the present invention, the spherical valve element 262 and the plunger 264 may a structure composed of a unitary member. In this case, such a unitary member corresponds to the valve element of the present invention.

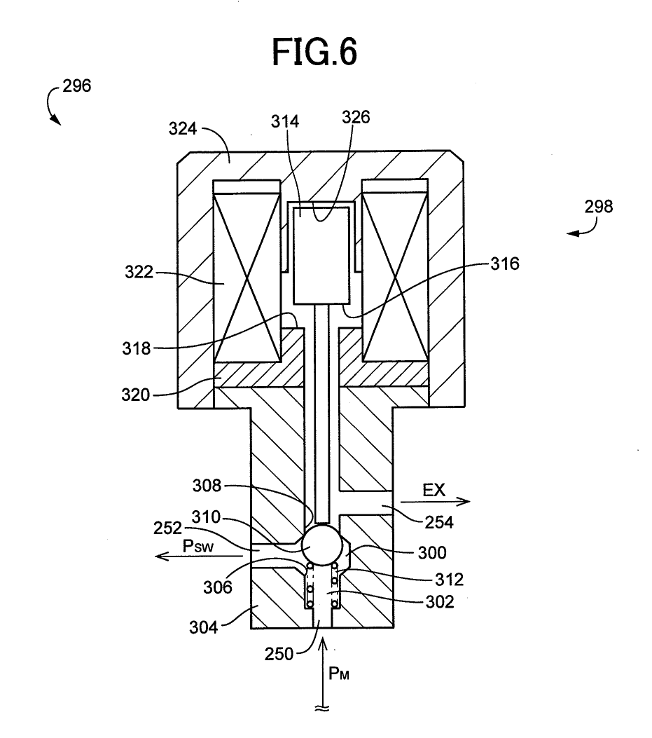

Although the switching electromagnetic solenoid valve 104 is composed of the three-way valve of the normally closed type, a three-way valve of a normally open type operative in a way opposite to the three-way valve of the normally closed type has been well known. FIG. 6 shows, for instance, a switching electromagnetic solenoid valve 296 of such a structure. With the hydraulic control circuit 100 shown in FIG. 4, when attempting to set the switching signal pressure P_{SW} to be the drain pressure, the electronic control device 90 electrically-magnetizes a switching electromagnetic solenoid 298 incorporated in the switching electromagnetic solenoid valve 296. In contrast, when attempting to set the switching signal pressure P_{SW} to be the modulator pressure P_{M}, the electronic control device 90 does not-electrically-magnetize the switching electromagnetic solenoid 298. The switching electromagnetic solenoid valve 296 of the normally open type may be used in place of the switching electromagnetic solenoid valve 104 under such conditions set forth above.

FIG. 6 is a cross-sectional view for illustrating the structure of the switching electromagnetic solenoid valve 296. The switching electromagnetic solenoid valve 296 includes: a main body member 304 made of non-magnetic material formed with the input port 250, the output port 252, the discharge port 254, a valve chamber 300 connected to the various ports 250, 252 and 254, and a spring receiving portion 302; and a spherical valve element 310 accommodated in the valve chamber 300 and having a diameter greater than an input-port-side opening aperture 306 and a discharge-port-side opening aperture 308 of the valve chamber 300. The switching electromagnetic solenoid valve 296 further includes: a spring 312 disposed in the spring receiving portion 302 for pressing the spherical valve element 310 against the discharge-port-side opening aperture 308 to block the discharge-port-side opening aperture 308; a two-tiered column shaped plunger 314 having one portion closer to the input port 250 and having a small diameter and the other portion having a large diameter; and the switching electromagnetic solenoid 298, all of which have the same axes as the center axis of the input port 250.

The switching electromagnetic solenoid 298 includes a core 320 through which the small diameter portion of the plunger 314 extends and which has a toric surface 318 facing one end face 316 of the large diameter portion of the plunger 314, a cylindrical coil 322 through which the large diameter portion of the plunger 314 extends, and a bottomed cylindrical yoke 324. The input port 250, the spherical valve element 310 and the plunger 314 are placed in such an order along the center axis of the input port 250. Within the valve chamber 300, an input-port-side opening aperture 306 and a discharge-port-side opening aperture 308 are placed in opposition to each other along the above-described center axis with the spherical valve element 310 being sandwiched within the valve chamber 256.

With the yoke 324 having an open end portion fixedly secured to the main body member 304 at one end in opposition to the input port 250, the yoke 324 and the main body member 304 constitute a housing body of the switching electromagnetic solenoid 298, within which the coil 322 and the core 320 are fixedly secured to the yoke 324. The plunger 314 has one end facing the spherical valve element 310 and the other end facing a stopper surface 326 formed on the yoke 324 at an inward area thereof.

With the switching electromagnetic solenoid 298 (coil 322) placed under a non-electrically-magnetized state, an operating state (mechanically operating state) of the switching electromagnetic solenoid valve 296 is placed under a turn-off state corresponding to a non-electrically-magnetized state. FIG. 6 shows such a turn-off state. With the switching electromagnetic solenoid valve 296 placed under the turn-off state, no magnetic force acts on the plunger 314 and, therefore, the plunger 314 does not cause the spherical valve element 310 from blocking the discharge-port-side opening aperture 308 due to the urging force of the spring 312. Thus, the spherical valve element 310 blocks the discharge-port-side opening aperture 308 due to the urging force of the spring 312. At the same time, the input port 250 and the output port 252 are brought into communication with each other to cause the switching signal pressure P_{SW} of the output port 252 to be the modulator pressure P_{M}.

On the contrary, with the switching electromagnetic solenoid 298 (coil 322) placed under an electrically-magnetized state, the operating state of the switching electromagnetic solenoid valve 296 is placed under a turn-on state corresponding to an electrically-magnetized state. With the switching electromagnetic solenoid valve 296 placed under the turn-on state, more particularly, the coil 322 generates a magnetic force with a magnitude greater than the urging force of the spring 312 and acting on the plunger 314 in a direction opposite to the urging force, causing the one end face 316 of the plunger 314 to be attracted toward the toric surface 318 of the core 320. This causes the spherical valve element 252 to block the input-port-side opening aperture 306. At the same time, the output port 252 and the discharge port 254 are brought into communication with each other to cause the switching signal pressure P_{SW} of the output port 252 to be a drain pressure.

Thus, the switching electromagnetic solenoid valve 296 is an on/off control valve having a structure in which the spherical valve element 310, actuated with the switching electromagnetic solenoid 298, blocks the input port 250 on current-supplying the switching electromagnetic solenoid 298 whereas on non-current-supplying the switching electromagnetic solenoid 298, the input port 250 and the output port 252 are brought into communication with each other. Like the switching electromagnetic solenoid valve 104, the switching electromagnetic solenoid 298 of the switching electromagnetic solenoid valve 296 corresponds to the solenoid of the present invention. Although the spherical valve element 310 corresponds to the valve element of the present invention, the spherical valve element 310 and the plunger 314 may take the form of a structure formed in a unitary member. In this case, such a unitary member corresponds to the valve element of the present invention. To describe for a confirmatory purpose, moreover, the hydraulic control circuit 100, shown in FIG. 4, will be described below with reference to a structure in which no switching electromagnetic solenoid valve 296 is used but the switching electromagnetic solenoid valve 104 is used unless otherwise indicated.

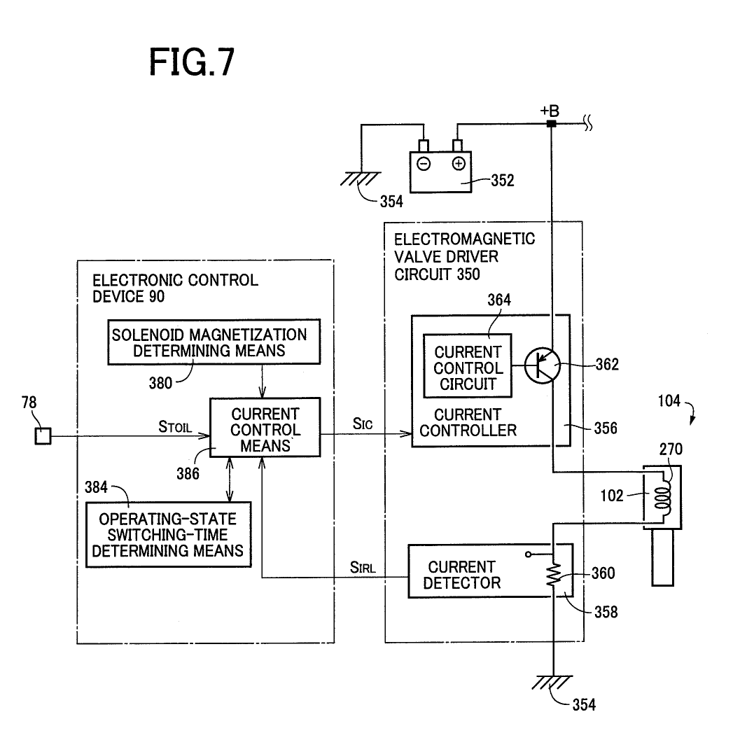

FIG. 7 is a view, illustrating a major part of an electromagnetic valve driver circuit 350 for controlling the operation of the switching electromagnetic solenoid valve 104 corresponding to the on/off control valve of the present invention, which represents a functional block diagram for illustrating a major part of a control function incorporated in the electronic control device 90 to which the present invention is applied.

The electronic control device 90 electrically-magnetizes or does not electrically-magnetizes the switching electromagnetic solenoid 102, incorporated in the switching electromagnetic solenoid valve 104 used in the hydraulic control circuit 100 (see FIG. 4), thereby switching the operating state of the switching electromagnetic solenoid valve 104 in the turn-on state or the turn-off state. Thus, description will be provided of FIG. 7 mainly with such a respect. A vehicle 8 of the present embodiment includes a battery 352 serving as a vehicular power source or a power supply having a negative electrode connected to a vehicle body 354 made of an electrically conductive material such as a steel plate or the like.

As shown in FIG. 7, the electronic control device 90 is applied with a detected current signal S_{IRL}, representing a current value current supplying to the switching electromagnetic solenoid 102, from an electromagnetic valve driver circuit 350 for driving the switching electromagnetic solenoid 102. In addition, the AT oil temperature sensor 78 applies the electronic control device 90 with an oil temperature signal S_{TOIL}, representing an AT oil temperature TEMP_{OIL} indicating a temperature of hydraulic oil supplied to the switching electromagnetic solenoid valve 104. Meanwhile, the electronic control device 90 outputs the electromagnetic valve driver circuit 350 with a current control signal S_{IC} for controlling the electric current current-supplying the switching electromagnetic solenoid 102.

The electromagnetic valve driver circuit 350 includes a current controller 356 connected in series between one terminal of the switching electromagnetic solenoid 102 and a positive terminal of the battery 352, and a current detector 358 connected in series between the other terminal of the switching electromagnetic solenoid 102 and the negative terminal, i.e., the vehicle body 354, of the battery 352.

The current detector 358 includes a current detecting element 360 connected in series between the other terminal of the switching electromagnetic solenoid 102 and the vehicle body 354 for detecting the current value I_{RL} (hereinafter referred to as “solenoid current value I_{RL}”) current-supplied to the switching electromagnetic solenoid 102 to output a detected current signal S_{IRL}, representing the solenoid current value I_{RL}, to the electronic control device 90.

The current detector 360 is, for instance, a current detecting resistor element, having resistance in the order of approximately 0.5Ω, which is connected between the other terminal of the switching electromagnetic solenoid 102 and the vehicle body 354 in series. The current detector 358 detects a voltage potential E_{RL} occurring across between both terminals of the current detecting element (resistor element) 360 to allow the calculation of the solenoid current value I_{RL} based on the detected voltage potential E_{RL} and a resistance value of the resistor element (current detecting element) 360.

The current controller 356 includes a current control element 362, connected between one terminal of the switching electromagnetic solenoid 102 and the positive terminal of the battery 352 in series, and a current control circuit 364 for controlling the current control element 362. With the current controller 356 controlled based on the current control signal S_{IC} delivered from the electronic control device 90, the current control signal S_{IC} is altered. Upon receipt of the current control signal S_{IC} representing a current value of 0 (zero), the current controller 356 allows the current control element 362 to interrupt the current-supplying of the switching electromagnetic solenoid 102.

The current control element 362 is, for instance, a PNP transistor having an emitter terminal connected to the positive terminal of the battery 352 and a collector terminal connected to one terminal of the switching electromagnetic solenoid 102. The current controller 356 sets the control current value I_{CON} (base current value) for the current control element 362 using the current control circuit 364 to regulate the solenoid current value I_{RL}.

The electronic control device 90 of the present embodiment controls the solenoid current value I_{RL} and, to this end, includes solenoid electric-magnetization determining portion or means 380, operating-state switching-time determining portion or means 384 and current control portion or means 386 shown in FIG. 7.

The solenoid electric-magnetization determining means 380 makes a query as to whether a solenoid electrically-magnetizing command is made to magnetize the switching electromagnetic solenoid 102 for the purpose of switching the operating state of the switching electromagnetic solenoid valve 104 from the turn-off state to the turn-on state. The solenoid electrically-magnetizing command is made, for instance, when attempting the switching signal P_{SW} to be se to the modulator pressure PM, and cancelled when attempting the switching signal P_{SW} to be set to the drain pressure P_{SW}.

The operating-state switching-time determining means 384 makes a query as to whether a given initial current-supplying time T_{INT} has elapsed from the issuance of a switching command to shift from the turn-off state to the turn-on state, i.e., a time (at which the solenoid electrically-magnetizing command is initiated) when the solenoid electrically-magnetizing command is initiated.

Here, the operating-state switching-time determining means 384 makes a query as to whether the initial current-supplying time T_{INT} has elapsed from the issuance of the solenoid electrically-magnetizing command. However, a query may be made as to whether the initial current-supplying time T_{INT} has elapsed from a time when the switching is made from the non-electrically-magnetized state to the electrically-magnetized state in response to the solenoid electrically-magnetizing command, i.e., a time at which the switching electromagnetic solenoid 102 is commenced to turn on.

Further, the “initial current-supplying time T_{INT}” is a time set on experimental tests for temporarily increasing the solenoid current value I_{RL} when beginning to magnetize the switching electromagnetic solenoid 102, i.e., when performing the switching operation from the turn-off state to the turn-on state. The term “mechanical response” of the switching electromagnetic solenoid valve 104 refers to switching response for the operating state of the switching electromagnetic solenoid valve 104 to be switched from the turn-off state to the turn-on state, when the switching electromagnetic solenoid 102 is electrically switched from the non-electrically-magnetized state to the electrically-magnetized state. The initial current-supplying time T_{INT} is determined by the current control means 386. Accordingly, prior to making a query as to whether there is an elapse of the initial current-supplying time T_{INT}, the operating-state switching-time determining means 384 reads out the determined initial current-supplying time T_{INT}. After the readout has been completed, a query is made as to whether the initial current-supplying time T_{INT} has elapsed. Detailed description will be provided of how the initial current-supplying time T_{INT} is determined.

The current control means 386 selectively switches the switching electromagnetic solenoid 102 in one of the electrically-magnetized state and the non-electrically-magnetized state. That is, when the solenoid electric-magnetization determining means 380 determines that no solenoid electrically-magnetizing command is generated, the current control signal S_{IC}, representing a zeroed solenoid current value I_{RL}, is output to the current control means 386. This causes the current control element 362 to interrupt the current-supplying of the switching electromagnetic solenoid 102, which is consequently placed in the non-electrically-magnetized state. On the contrary, if the solenoid electric-magnetization determining means 380 determines that the solenoid electrically-magnetizing command is initiated, the current control means 386 allows the current controller 356 to begin current-supplying the switching electromagnetic solenoid 102, which is consequently placed in the electrically-magnetized state.

Further, under a circumstance where the switching electromagnetic solenoid 102 is placed in the electrically-magnetized state, the current control means 386 allows the solenoid current value I_{RL} to be set to an operation initiating current value I_{RN} required for the turn-off state to be switched to the turn-on state at the beginning of magnetization. After the switching made to the turn-on state, a solenoid control is executed with a sustaining current vale I_{HD} lower than the operation initiating current value I_{RN} required for sustaining the turn-on state. To describe for confirmatory purpose, all of the solenoid current value I_{RL}, the operation initiating current value I_{RN} and the sustaining current vale I_{HD} represent actual current values current-supplying to the switching electromagnetic solenoid 102. That is, the operation initiating current value I_{RN} means the solenoid current value I_{RN} at the beginning of the magnetization and the sustaining current vale I_{HD} means the solenoid current value I_{RL} appearing after the switching is made to the turn-on state.

The solenoid control will be described below in detail. When the solenoid electric-magnetization determining means 380 determines that the solenoid electrically-magnetizing command is generated and the operating-state switching-time determining means 384 determines that no given initial current-supplying time T_{INT} has elapsed from the issuance of the solenoid electrically-magnetizing command, the current control means 386 sets the solenoid current value I_{RL} to be the operation initiating current value I_{RN}. In brief, a phase in which the initial current-supplying time T_{INT} elapses from the issuance of the solenoid electrically-magnetizing command corresponds to the beginning of magnetization. Upon receipt of the solenoid electrically-magnetizing command, the current control means 386 executes a solenoid initial-operation control in response to the solenoid current value I_{RL} in line with the operation initiating current value I_{RN} until the initial current-supplying time T_{INT} has elapsed from the issuance of the solenoid electrically-magnetizing command. More particularly, during the solenoid initial-operation control, the current control means 386 outputs the current control signal S_{IC}, corresponding to a predetermined target operation initiating current value I_{TRN}, to the current controller 356. This allows the current controller 356 to set the control current value I_{CON} at a level depending on the current control signal S_{IC}, thereby permitting the operation initiating current value I_{RN} (solenoid current value I_{RL}) to be controlled so as to reach the target operation initiating current value I_{TRN}.

When the solenoid electric-magnetization determining means 380 determines that the solenoid electrically-magnetizing command is generated and the operating-state switching-time determining means 384 determines that the given initial current-supplying time T_{INT} has elapsed from the issuance of the solenoid electrically-magnetizing command, the current control means 386 executes a solenoid sustaining current control in response to the solenoid current value I_{RL} in line with the sustaining current value I_{HD}. In brief, when the solenoid electrically-magnetizing command is generated, if the initial current-supplying time T_{INT} has elapsed from the issuance of the solenoid electrically-magnetizing command, the current control means 386 executes the solenoid sustaining current control. In such a way, the current control means 386 executes the solenoid control in which the solenoid initial-operation control is initiated before an elapse of the initial current-supplying time T_{INT} whereas executing the solenoid sustaining current control after the elapse of the initial current-supplying time T_{INT}.

The current control means 386 executes the solenoid sustaining current control in such a fashion described above. In such a case, a feedback control is performed to allow the sustaining current value I_{HD} (solenoid current value I_{RL}) to approach the predetermined target operation initiating current value I_{TRN}, thereby executing the solenoid sustaining current control. More particularly, the feedback control is performed so as to regulate the control current value I_{CON} of the current control element 362 such that the sustaining current value I_{HD} lies at the predetermined target operation initiating current value I_{TRN}. To this end, the current control means 386 executes the feedback control in a manner described below.

First, the current control means 386 reads the sustaining current value I_{HD} when supplied with the solenoid current value I_{RL} from the current detector 358. Then, the current control means 386 calculates a control current correcting value ΔI_{CON} using a formula expressed below. Next, the current control means 386 adds the control current correcting value ΔI_{CON}, determined in a preceding setting during the feedback control, to the control current value I_{CON} to re-determine the same, thereby updating the control current value I_{CON}. Subsequently, the current control means 386 outputs the current control signal S_{IC} to the current controller 356, which in turn is caused to execute the operation to current-supply the switching electromagnetic solenoid 102 with the updated current control signal S_{IC}. The current control means 386 performs the feedback control in such a way. Further, although the control current value I_{CON} may have a zeroed initial value, i.e., preferably, the initial value of the control current value I_{CON} may be determined on experimental tests conducted to minimize the control current correcting value ΔI_{CON} from the initiation of the feedback control and later.

ΔI_{CON}=KP×(I_{THD}−I_{HD})+KI×∫(I_{THD}−I_{HD})×dt (1)

Further, the formula (1) above described, represents a feedback control formula having a right-hand side with a first term representing a proportional term and a second term representing an integral term. “KP” in the above formula (1) represents a proportional gain and “KI” represents an integral gain. In the above formula (1), the proportional gain KP and the integral gain KI are pre-determined on experimental tests such that a deviation e(=I_{THD}−I_{HD}) is stably converged on an earlier stage.

The target sustaining current value I_{THD} is a target current value for the sustaining current value I_{HD} pre-determined on experimental tests under a situation where the switching electromagnetic solenoid 102 remains in the electrically-magnetized state. It is determined such that the switching electromagnetic solenoid 102 can be maintained in the turn-on state, and the sustaining current value I_{HD} can be decreased as quickly as possible for reducing power consumption arising when magnetizing the switching electromagnetic solenoid 102.

Further, the target operation initiating current value I_{TRN}, representing a target current value for the operation initiating current value I_{RN} higher than the target sustaining current value I_{THD}, is a target current value, determined on experimental tests. It is required for switching the operating state of the switching electromagnetic solenoid valve 104 from the turn-off state to the turn-on. For the purpose of improving mechanical response of the switching electromagnetic solenoid valve 104, the target operation initiating current value I_{TRN} is set or determined based on a switching response characteristic of the switching electromagnetic solenoid valve 104. Such a routine will be described below.

The term “switching response characteristic” of the switching electromagnetic solenoid valve 104 represents the relationship between the mechanical response of the switching electromagnetic solenoid valve 104 and a response impact factor causing the response to vary. The response impact factor may include, for instance, the modulator pressure P_{M} (hereinafter referred to as “supply pressure P_{M}”) representing a pressure of hydraulic oil supplied to the switching electromagnetic solenoid valve 104, a structure of the switching electromagnetic solenoid valve 104, and an ambient temperature of the switching electromagnetic solenoid valve 104, etc. The ambient temperature of the switching electromagnetic solenoid valve 104 may be exemplified as a temperature (AT oil temperature TEMP_{OIL}) of fluid supplied to the switching electromagnetic solenoid valve 104 and an external temperature in the vicinity of the switching electromagnetic solenoid valve 104, etc.

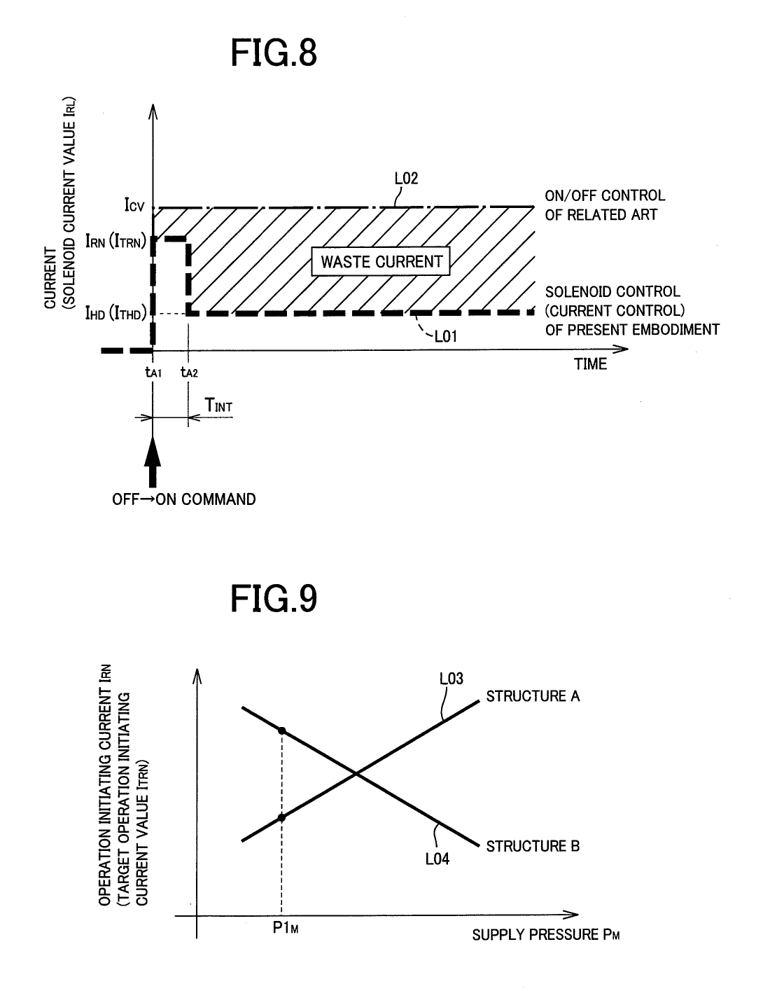

FIG. 8 is a timing chart of the solenoid current value I_{RL} for illustrating a related art on/off control, for the switching electromagnetic solenoid 102 to be switched into the electrically-magnetized state or the non-electrically-magnetized state in response to a turn-on or turn-off state of an output of the battery 352, and the solenoid control of the present embodiment, i.e., the solenoid control (current control) executed by the current control means 386. In FIG. 8, a broken line L01 represents a timing chart for the solenoid control of the present embodiment and a single dot line L02 represents a timing chart for the related art on/off control. To facilitate understanding, moreover, at various time instants in FIG. 8, the operation initiating current value I_{RN} matches the target operation initiating current value I_{TRN} and the sustaining current value I_{HD} matches the target sustaining current value I_{THD}.

At the timing t_{A1} in FIG. 8, the solenoid electric-magnetization determining means 380 determines weather or not the solenoid electrically-magnetization command is made. In both the on/off control in the conventional art and the solenoid control in the present embodiment, the switching electromagnetic solenoid 102 is switched from the non-electrically-magnetized state to the electrically-magnetized state at the timing t_{A1}. Noted that in the on/off control in the conventional art, the electric-magnetization current value I_{CV} of the switching electromagnetic solenoid 102 is uniquely determined based on a constant applied voltage applied thereto and the coil resistance thereof, as shown in chain and dot line L02. This electric-magnetization current value I_{CV} is maintained even after the timing t_{A1}.

With the solenoid control of the present embodiment, on the contrary, the current control means 386 executes the solenoid initial-operation control for a time period until the initial current-supplying time T_{INT} has elapsed from the issuance of the solenoid electrically-magnetizing command (at time t_{A1}), i.e., a time interval between times t_{A1} and t_{A2}. Accordingly, at time t_{A1}, the solenoid current value I_{RL} rises up to the target operation initiating current value I_{TRN}. During a time period between the times t_{A1} and t_{A2}, the solenoid current value I_{RL} is maintained at the target operation initiating current value I_{TRN}. That is, the solenoid current value I_{RL} continuously remains constant between the times t_{A1} and t_{A2}.

Next at time t_{A2}, the operating-state switching-time determining means 384 determines that the initial current-supplying time T_{INT} has elapsed, and the current control means 386 executes the solenoid sustaining current control. Accordingly, the solenoid current value I_{RL} drops to the target sustaining current value I_{THD} at time t_{A2} and the solenoid current value I_{RL} is maintained at the target sustaining current value I_{THD} at time t_{A2} and later. That is, the target sustaining current value I_{THD} continues at time t_{A2} and later.

As will be apparent from FIG. 8, during the electrically-magnetized state of the switching electromagnetic solenoid 102 when executing the solenoid control of the present embodiment, the solenoid initial-operation control and the solenoid sustaining current control are executed, i.e., the operation is executed to control the magnetization current of the switching electromagnetic solenoid 102. This causes the solenoid current value I_{RL} to be lower than that achieved with the related art on/off control and it turns out that, especially at time t_{A2} and later, a significant reduction is achieved in the solenoid current value I_{RL}. That is, executing the solenoid initial-operation control and the solenoid sustaining current control reduces waste current (hatched area in FIG. 8) corresponding to the amount of reduction in the solenoid current value I_{RL} achieved to be lower than that of the related art on/off control. In addition, such a reduction in waste current reduces a calorific value of the switching electromagnetic solenoid 102 to a degree depending on such a reduction.

As set forth above, the current control means 386 sequentially executes the solenoid initial-operation control and the solenoid sustaining current control. Hereunder, detailed description will be provided of how the initial current-supplying time T_{INT}, the target operation initiating current value I_{TRN} and the target sustaining current value I_{THD} are determined.

FIG. 9 is a graph showing the relationship between the supply pressure P_{M} of the switching electromagnetic solenoid valve 104 and the operation initiating current value I_{RN}, obtained on experimental tests with a view to improving and stabilizing mechanical response of the switching electromagnetic solenoid valve 104, i.e., the relationship between the supply pressure P_{M} and the target operation initiating current value I_{TRN} representing a target value of the operation initiating current value I_{RN}. FIG. 9 shows two relationships different from each other and indicated by solid lines L03 and L04, respectively. This is because the relationships, shown in FIG. 9, between the supply pressure P_{M} and the operation initiating current value I_{RN} (target operation initiating current value I_{TRN}) are exemplified to be different from each other depending on structures of electromagnetic valves targeted to be controlled. With a structure “A” shown in FIG. 9, the stable switching response is ensured as shown by the solid line L03 representing a structure needed to be controlled such that the higher the supply pressure P_{M}, the higher will be the operation initiating current value I_{RN} (target operation initiating current value I_{TRN}). In contrast, as shown by a solid line L04, a structure B means a structure needed to be controlled such that the higher the supply pressure P_{M}, the lower will be the operation initiating current value I_{RN} (target operation initiating current value I_{TRN}). The switching electromagnetic solenoid valve 104 of the present embodiment corresponds to the structure B, shown in FIG. 9, wherein the operation initiating current value I_{RN} (target operation initiating current value I_{TRN}) is determined based on the relationship indicated by the solid line L04 in FIG. 9.

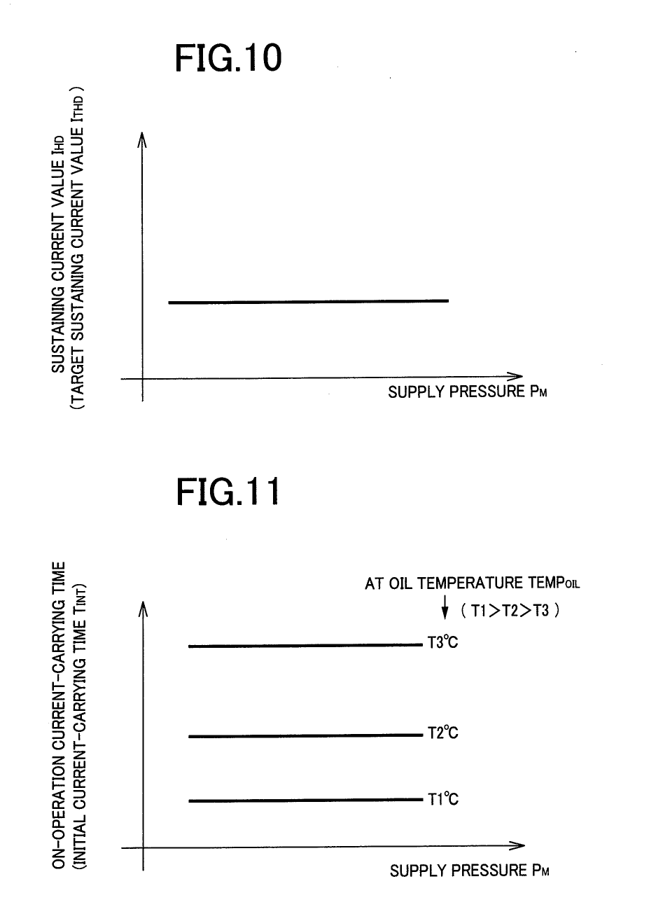

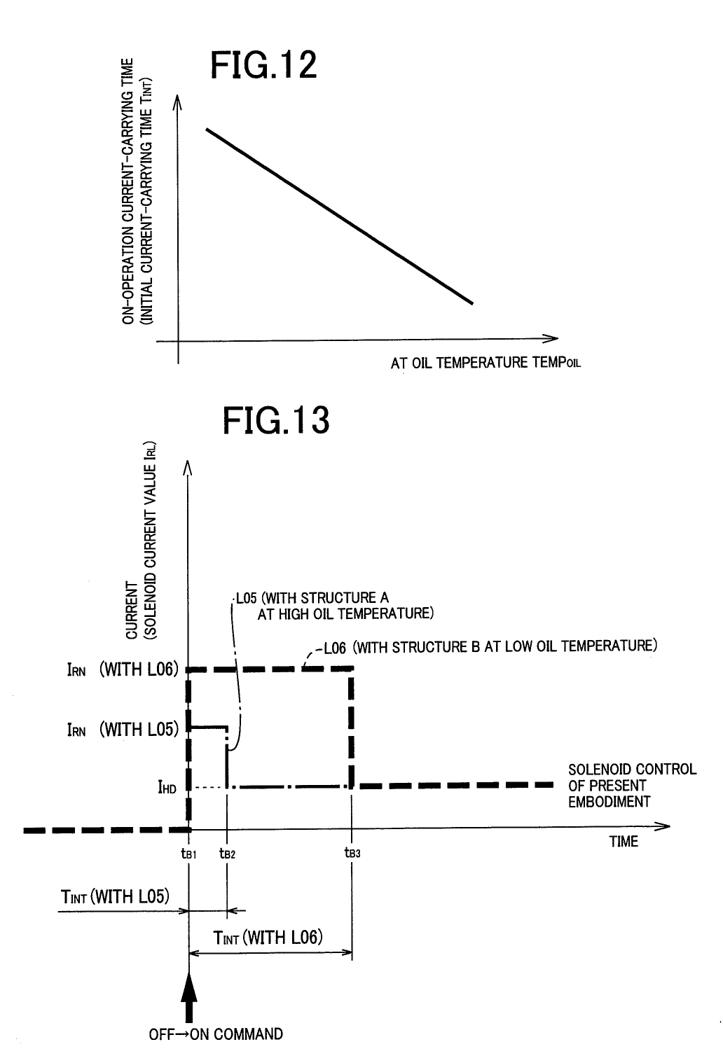

On the contrary, the switching electromagnetic solenoid valve 296, shown in FIG. 6, corresponds to the structure “A” shown in FIG. 9, wherein the operation initiating current value I_{RN} (target operation initiating current value I_{TRN}) is determined based on the relationship indicated by the solid line L03 in FIG. 9, provided that the hydraulic control circuit 100 shown in FIG. 4, employs the switching electromagnetic solenoid valve 296 in place of the switching electromagnetic solenoid valve 104. FIG. 10 is a view showing the relationship between the supply pressure P_{M} and the sustaining current value I_{HD}, obtained on experimental tests so as to enable the turn-on state of the switching electromagnetic solenoid valve 104 to be sustained, while enabling a reduction in power consumption of the switching electromagnetic solenoid 102 caused by the magnetization thereof, i.e., the relationship between the supply pressure P_{M} and the target sustaining current value I_{THD} representing a target value of the sustaining current value I_{HD}. FIG. 11 is a view showing the relationships among the AT oil temperature TEMP_{OIL} representing the ambient temperature of the switching electromagnetic solenoid valve 104, the supply pressure P_{M} and the initial current-supplying time (on-operation magnetizing time) T_{INT} obtained on experimental tests with a view to improving and stabilizing mechanical response (operating response) of the switching electromagnetic solenoid valve 104. FIG. 11 shows that the AT oil temperature TEMP_{OIL} falls in the relationship expressed as “T1>T2>T3”. FIG. 11 shows that if the AT oil temperature TEMP_{OIL} is high, the initial current-supplying time T_{INT} is shorter than that of a case in which the AT oil temperature TEMP_{OIL} is low and, with a view to representing such a point to be easily comprehensive, FIG. 12 shows another relationship altered to the relationship between the AT oil temperature TEMPₒₙ and the initial current-supplying time (on-operation current-supplying time) T_{INT} shown in FIG. 11.

With reference to the relationships shown in FIGS. 9 and 12, the current control means 386 determines the initial current-supplying time T_{INT} and the target operation initiating current value I_{TRN} based on the AT oil temperature TEMP_{OIL}, representing the temperature of hydraulic oil supplied to the switching electromagnetic solenoid valve 104, and the supply pressure P_{M}. In other words, the current control means 386 determines a current variation for the solenoid initial-operation control depending on such factors. In particular, the operation is executed to determine the operation initiating current value I_{RN} to remain in the initial current-supplying time T_{INT}.

More particularly, the relationship (see FIG. 9) relevant to the solid line L04, determined based on the structure of the switching electromagnetic solenoid valve 104, is pre-stored in the current control means 386. The current control means 386 determines the operation initiating current value I_{RN} based on the supply pressure P_{M} by referring to the pre-stored solid line L04. That is, the operation is executed to determine the target operation initiating current value I_{TRN} based on the supply pressure P_{M}. As indicated by the solid line L04, more particularly, the current control means 386 executes the operation such that the higher the supply pressure P_{M}, the lower will be the operation initiating current value I_{RN} (the target operation initiating current value I_{TRN}).

Then, the current control means 386 determines the initial current-supplying time T_{INT} based on the ambient temperature of the switching electromagnetic solenoid valve 104, i.e., the AT oil temperature TEMP_{OIL} by referring to the pre-stored relationship shown in FIG. 12. As shown in FIG. 12, more particularly, the lower the AT oil temperature TEMP_{OIL} is, the longer will be the initial current-supplying time T_{INT}. This is because, as shown in FIG. 12, deterioration occurs in operating response due to the fact that the lower the AT oil temperature TEMP_{OIL}, the higher will be the viscosity of hydraulic oil provided that the switching electromagnetic solenoid 102 is electrically-magnetized under the same condition.

If the solenoid electric-magnetization determining means 380 determines that the solenoid electrically-magnetizing command is issued, further, the current control means 386 determines the initial current-supplying time T_{INT} and the target operation initiating current value I_{TRN} prior to a step of executing the solenoid initial-operation control. The initial current-supplying time T_{INT} and the target operation initiating current value I_{TRN} may be determined and updated as needed regardless of the determination of the solenoid electric-magnetization determining means 380. Moreover, under a circumstance where the hydraulic control circuit 100, shown in FIG. 4, employs the switching electromagnetic solenoid valve 296 in place of the switching electromagnetic solenoid valve 104, the current control means 386 determines the operation initiating current value I_{RN} (the target operation initiating current value I_{TRN}) based on the supply pressure P_{M}, Under such a circumstance, the operation is executed by referring not to the solid line L04 but to the solid line L03 such that the higher the supply pressure P_{M}, the higher will be the operation initiating current value I_{RN} (the target operation initiating current value I_{TRN}).

As shown in FIG. 10, furthermore, no need arises to alter the target sustaining current value I_{THD} depending on the supply pressure P_{M}. Therefore, the current control means 386 allows the target sustaining current value I_{THD} to lie at a fixed value regardless of the AT oil temperature TEMP_{OIL}. Moreover, the target sustaining current value I_{THD} is obtained based on, for instance, the number of turns of the coil 270 and the urging force of the spring 266 regardless of whether the relationship between the supply pressure P_{M} and the operation initiating current value I_{RN} belongs to the relationship indicated by the solid line L03 or the relationship indicated by the solid line L04 and pre-stored in the current control means 386.

A timing chart for illustrating a variation in the operation initiating current value I_{RN}, when the switching electromagnetic solenoid 102 is current-supplied, i.e., electrically-magnetized in response to the initial current-supplying time T_{INT}, the target operation initiating current value I_{TRN} and the target sustaining current value I_{THD} determined in such a way mentioned above, is shown in FIG. 13.

FIG. 13 is a view, illustrating how the operation initiating current value I_{RN} varies in timing chart depending on the structure of the electromagnetic valve, the supply pressure P_{M} and the AT oil temperature TEMP_{OIL}. It exemplifies a case under which the supply pressure P_{M} is low in FIG. 9, i.e., for instance, a case wherein the supply pressure P_{M} lies at a value of P1_{M}. A single dot line L05, shown in FIG. 5, represents a timing chart of the solenoid current value I_{RL} when the AT oil temperature TEMP_{OIL} remains at a relatively high temperature under a situation where it is supposed that the hydraulic control circuit 100, shown in FIG. 4, employs the switching electromagnetic solenoid valve 296 with the structure A in place of the switching electromagnetic solenoid valve 104. Meanwhile, a broken line L06, shown in FIG. 13, represents the timing chart of the solenoid current value I_{RL} when the AT oil temperature TEMP_{OIL} remains at a relatively low temperature under a situation where the hydraulic control circuit 100, shown in FIG. 4, employs the switching electromagnetic solenoid valve 104 with the structure B. To facilitate understanding, with various times in FIG. 13, it is supposed that the operation initiating current value I_{RN} matches the target operation initiating current value I_{TRN} and the sustaining current value I_{HD} matches the switching electromagnetic solenoid valve 104 representing the target valve.

If the supply pressure P_{M} lies at P1_{M}, the structure “A” has the operation initiating current value I_{RN} lower than that of the structure B as will be understood from FIG. 9. Therefore, at time t_{B1} in FIG. 13, the operation initiating current value I_{RN}, indicated by the timing chart of the single dot line L05, is lower than that indicated by the timing chart of the broken line L06. In addition, the higher the AT oil temperature TEMP_{OIL}, the shorter will be the initial current-supplying time T_{INT} as will be understood from FIG. 12. Therefore, the initial current-supplying time T_{INT} (between times t_{B1} and t_{B2}), indicated by the timing chart of the single dot line L05, becomes shorter in time than the initial current-supplying time T_{INT} (between times t_{B1} and t_{B3}) indicated by the timing chart of the broken line L06.

Further, the target sustaining current value I_{THD} is set to the fixed value regardless of the AT oil temperature TEMP_{OIL}. As will be understood from FIG. 13, therefore, during a time subsequent to time t_{B2} and later in the timing chart of the single dot line L05 and another time subsequent to time t_{B3} and later in the timing chart of the broken line L06, the sustaining current value I_{HD} remains at the target sustaining current value I_{THD}.

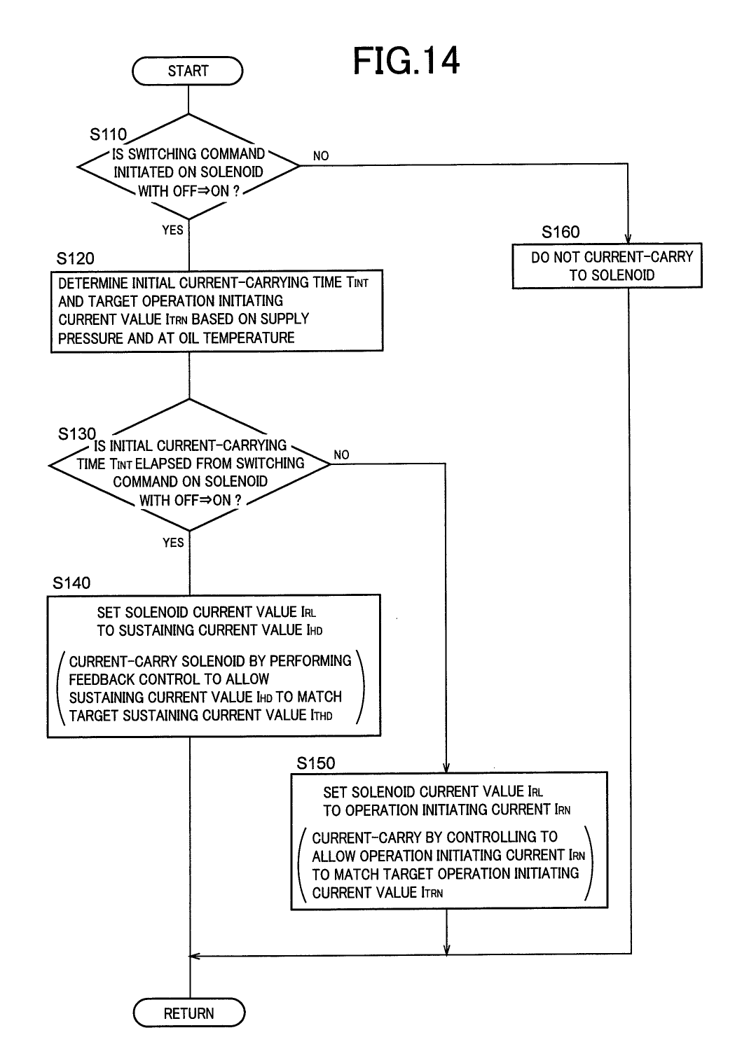

FIG. 14 is a flow chart, illustrating a major part of control operation to be executed with the electronic control device 90, i.e., control operation for reducing the electric-magnetization current of the switching electromagnetic solenoid 102 to be electrically-magnetized, which is repeatedly executed in the order of, for instance, several few milliseconds to several tens milliseconds.

First, at step (hereinafter the term “step” will be omitted) 5110 corresponding to the solenoid electric-magnetization determining means 380, a query is made as to whether the solenoid electrically-magnetizing command is made. If the answer to the query at S110 is yes, i.e., when the solenoid electrically-magnetizing command is made, the routine goes to S120. In contrast, if the answer to the query at S110 is no, the routine goes to S160.

At S120 corresponding to the current control means 386, the initial current-supplying time T_{INT} and the target operation initiating current value I_{TRN} are determined based on the AT oil temperature TEMP_{OIL} and the supply pressure P_{M}. More particularly, the target operation initiating current value I_{TRN} is determined based on the supply pressure P_{M} by referring to the relationship (see FIG. 9) of the solid line L04. Then, the initial current-supplying time T_{INT} is determined based on the AT oil temperature TEMP_{OIL} by referring to the relationship shown in FIG. 12.

At S130 corresponding to the operating-state switching-time determining means 384, a query is made as to whether the initial current-supplying time T_{INT} has elapsed from the solenoid electrically-magnetizing command. That is, a query is made as to whether the initial current-supplying time T_{INT} has elapsed from a time when the answer to S110 is switched from a negative determination to a positive determination. If the answer to S130 is yes, i.e., when the initial current-supplying time T_{INT} has elapsed from the solenoid electrically-magnetizing command, the routine goes to S140. On the contrary, if the answer to S130 is no, the routine goes to S150.

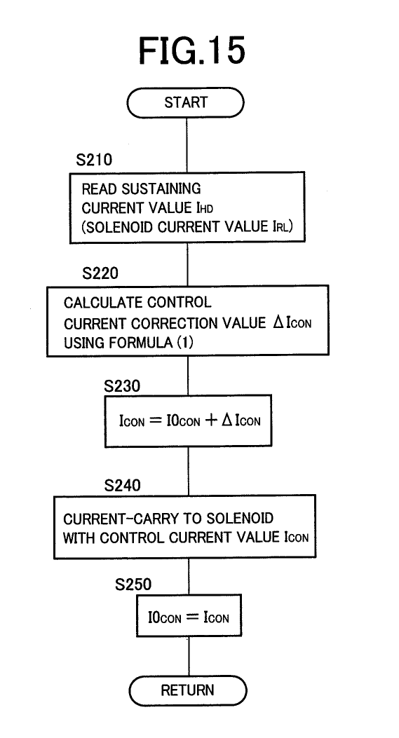

At S140 corresponding to the current control means 386, the solenoid current value I_{RL} is set to the sustaining current value I_{HD}. In this moment, the feedback control is performed to allow the sustaining current value I_{HD} (solenoid current value I_{RL}) to match the target sustaining current value I_{THD}. In particular, during such a feedback control, a control operation, shown in FIG. 15, is repeatedly executed.

FIG. 15 is a flow chart illustrating a major part of the feedback control, i.e., the control operation for regulating the control current value I_{CON} so as to allow the sustaining current value I_{HD} to match the target sustaining current value I_{THD}. A routine, shown in FIG. 15, corresponds to the current control means 386. At S210 in FIG. 15, the operation is executed to read the sustaining current value I_{HD} from the current detector 358.

At succeeding S220, a control-current correcting amount ΔI_{CON} is calculated by referring to the above-mentioned formula (1). At consecutive S230, a product, obtained by adding the control-current correcting amount ΔI_{CON} to a control current value I0_{CON} (hereinafter referred to as “preceding control current value I0_{CON}”) at time determined on a preceding state in the flow chart shown in FIG. 15, is set to the control current value I_{CON} for updating the control current value I_{CON}, as expressed by a formula (2) given below.

I_{CON}−I0_{CON}+ΔI_{CON} (2)

At subsequent S240, the operation is executed to electrically-magnetize the switching electromagnetic solenoid 102 with the control current value I_{CON} updated at S230. That is, the current control element 362 is controlled with the updated control current value I_{CON}, thereby determining the sustaining current value I_{HD}.

At succeeding S250, the control current value I_{CON} updated at S230 is set to be the preceding control current value I0_{CON} as expressed by a formula (3) given below.

I0_{CON}=I_{CON} (3)

Turning back to FIG. 14, at S150 corresponding to the current control means 386, the solenoid current value I_{RL} is set to the operation initiating current value I_{RN}. In this moment, the operation is controlled such that the operation initiating current value I_{RN} (solenoid current value I_{RL}) is matched to the target operation initiating current value I_{TRN}.

At S160 corresponding to the current control means 386, the current control element 362 interrupts the current-supplying of the switching electromagnetic solenoid 102, which is consequently placed in a non-electrically-magnetized state.

The present embodiment has various advantages (A1) to (A11) as listed below.

(A1) With the present embodiment, when the switching electromagnetic solenoid 102 is placed under the electrically-magnetized state, the current control means 386 allows the solenoid current value I_{RL} to be set to the operation initiating current value I_{RN} required for switching the turn-off state to the turn-on during the beginning of the magnetization, whereas after the switching is executed to establish the turn-on, the solenoid current value I_{RL} is set to the sustaining current value I_{HD} lower than the operation initiating current value I_{RN} for sustaining the turn-on. Accordingly, this can reduce the solenoid current value IRL without impairing the operation of the switching electromagnetic solenoid valve 104. As shown in FIG. 8, therefore, the waste electric current is minimized to be lower than that achieved with the related art on/off control, minimizing power consumption of the switching electromagnetic solenoid valve 104.

Further, the minimization of the waste electric current results in the suppression of an increase in temperature of the coil 270 caused by the current-supplying thereof, thereby enabling the suppression of an increase in resistance value of the coil 270 accordingly. Such a reduction in power consumption results in an effective advantage particularly when controllably driving a vehicular power generator (alternator) on a demand to generate electric power, enabling improvement in fuel economy.

(A2) With the present embodiment, further, the reduction in waste electric power as shown in FIG. 8 reduces heat developed by the coil 270 accompanied by a decrease in need to form the switching electromagnetic solenoid 102 in a large size with a view to increasing radiation performance of the coil 270. Therefore, this can provide an increased freedom in design of the switching electromagnetic solenoid 102 to make an optimum design to allow the switching electromagnetic solenoid 102 to output a desired attraction force. For instance, it becomes possible to achieve the thinning of a coil winding wire and a reduction in the number of turns, thereby enabling the miniaturization of the switching electromagnetic solenoid 102.
(A3) With the present embodiment, furthermore, the current control means 386 performs the feedback control such that the sustaining current value I_{HD} approaches the predetermined target sustaining current value I_{THD}. With the turn-on being sustained, therefore, the sustaining current value I_{HD} is stably converged to the target sustaining current value I_{THD}, enabling the turn-on to be reliably sustained.
(A4) With the present embodiment, moreover, when the solenoid electrically-magnetizing command is issued, the current control means 386 executes the operation such that the solenoid current value I_{RL} is set to the operation initiating current value I_{RN} until the initial current-supplying time T_{INT} has elapsed from the issuance of the solenoid electrically-magnetizing command while compelling the solenoid current value I_{RL} to be set to the sustaining current value I_{HD} after the elapse of the initial current-supplying time T_{INT}. Accordingly, with the operating-state switching-time determining means 384 making a query as to whether the initial current-supplying time T_{INT} has elapsed, the solenoid current value I_{RL} is lowered in a range from the operation initiating current value I_{RN} to the sustaining current value I_{HD} at appropriate timing, thereby minimizing power consumption of the switching electromagnetic solenoid valve 104.
(A5) The initial current-supplying time T_{INT} is set to an extremely short period of time for the beginning of the magnetization and, hence, mainly lowering the sustaining current value I_{HD} suppresses heat developed in the coil 270 such that the solenoid current value I_{RL} provides almost no adverse affect on heat developed by the coil 270. With the present embodiment, accordingly, mainly lowering the sustaining current value I_{HD} reduces heat developed by the coil 270, and the solenoid current value I_{RL} can be set to the operation initiating current value I_{RN} higher than the sustaining current value I_{HD} during the beginning of the magnetization. This allows the switching electromagnetic solenoid 102 to have an increased electromotive force with almost no increase in a heat value of the coil 270, thereby capable of increasing operating response of the switching electromagnetic solenoid valve 104.

In FIG. 8, the operation initiating current value I_{RN} is set to be lower than the electric-magnetization current value I_{CV} appearing in the related art on/off control. In contrast, setting the operation initiating current value I_{RN} to a value higher than the electric-magnetization current value I_{CV} achieves further improvement in operating response than that achieved in the related art on/off control. In this moment, setting the sustaining current value I_{HD} to a value lower than the electric-magnetization current value I_{CV} as shown in FIG. 8 can adequately minimize the heat value of the coil 270.

(A6) With the present embodiment, besides, the current control means 386 determines the initial current-supplying time T_{INT} based on the AT oil temperature TEMP_{OIL} by referring to the pre-stored relationship shown in FIG. 12. This ensures mechanical response of the switching electromagnetic solenoid valve 104 with no impact on the AT oil temperature TEMP_{OIL}.
(A7) With the present embodiment, additionally, the current control means 386 determines the initial current-supplying time T_{INT} as shown in FIG. 12, such that the lower the AT oil temperature TEMP_{OIL}, the longer will be the initial current-supplying time T_{INT}. This can avoid the AT oil temperature TEMP_{OIL} from giving an impact to mechanical response of the switching electromagnetic solenoid valve 104. As a result, the switching electromagnetic solenoid valve 104 can ensure to have stable mechanical response.
(A8) With the present embodiment, further, the current control means 386 determines the operation initiating current value I_{RN} based on the supply pressure P_{M} by referring to the pre-stored relationship (see FIG. 9) of the solid line L04, thereby enabling the switching electromagnetic solenoid valve 104 to ensure appropriate mechanical response.
(A9) With the present embodiment, furthermore, the switching electromagnetic solenoid valve 104 takes a structure to allow the spherical valve element 262, actuated by the switching electromagnetic solenoid 102, to communicate the input port 250 and the output port 252 with each other when the switching electromagnetic solenoid 102 is current-supplied. On the contrary, when the switching electromagnetic solenoid 102 is not current-supplied, the spherical valve element 262 closes the input port 250. Therefore, the supply pressure P_{M}, supplied to the input port 250, acts in a direction to facilitate switching the turn-off state to the turn-on.

In this respect, the current control means 386 regulates the operation initiating current value I_{RN} such that the higher the supply pressure P_{M}, the lower will be the operation initiating current value I_{RN}. Therefore, it becomes possible to avoid a pressure (supply pressure) P_{M} of hydraulic oil from adversely affecting mechanical response of the switching electromagnetic solenoid valve 104 in line with the structure of the switching electromagnetic solenoid valve 104. As a result, the switching electromagnetic solenoid valve 104 can ensure stable mechanical response.

(A10) With the present embodiment, moreover, the switching electromagnetic solenoid valve 296 shown in FIG. 6 takes a structure to allow the spherical valve element 310, actuated by the switching electromagnetic solenoid 298, to close the input port 250 when the switching electromagnetic solenoid 298 is current-supplied. On the contrary, when the switching electromagnetic solenoid 298 is not current-supplied, the input port 250 and the output port 252 are brought into communication with each other. Accordingly, the pressure P_{M} of hydraulic oil supplied to the input port 250, acts in a direction to interrupt the switching from the turn-off state to the turn-on. If the switching electromagnetic solenoid valve 296 may be used in place of the switching electromagnetic solenoid valve 104 in the hydraulic control circuit shown in FIG. 4. For instance, if the switching electromagnetic solenoid valve 296 is used in such a way, the current control means 386 regulates the operation initiating current value I_{RN} such that the higher the supply pressure P_{M}, the higher will be the operation initiating current value I_{RN}. This can avoid the pressure (supply pressure) P_{M} of hydraulic oil from adversely affecting mechanical response of the switching electromagnetic solenoid valve 296 in line with the structure of the switching electromagnetic solenoid valve 296. As a result, the switching electromagnetic solenoid valve 296 can ensure stable mechanical response.

(A11) With the present embodiment, besides, the initial current-supplying time T_{INT} and the target operation initiating current value I_{TRN} are determined based on the AT oil temperature TEMP_{OIL} and the supply pressure P_{M} in line with the structure of the switching electromagnetic solenoid valve 104. This enables an optimum current control to be performed for an electric current to be controlled with neither excess nor deficiency during the electrically-magnetized state of the switching electromagnetic solenoid 102.

Consecutively, description will be provided of other embodiments according to the present invention. In the following description, like reference characters designate like or corresponding component parts common to those of various embodiments and description of the same is herein omitted.

### Second Embodiment

The first embodiment has been set forth above with reference to a case in which the present invention is applied to the control device of the engine propelled vehicle. On the contrary, the second embodiment will be described below with reference to a case in which the present invention is applied to a control device of a hybrid vehicle. Also, for simplicity of description, description will be provided with a focus on differing points.

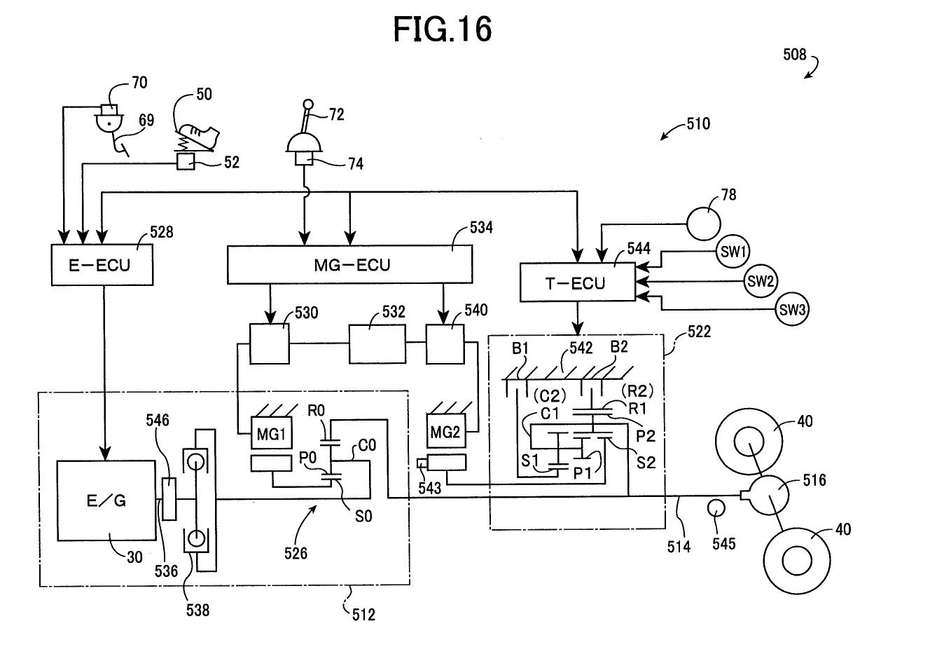

FIG. 16 is a schematic structural diagram illustrating a hybrid drive apparatus 510 for a vehicle 508 including the control device to which the present invention is applied. In FIG. 16, with the hybrid drive apparatus 510, a first drive-force source 12, acting as a main drive power source in the vehicle 508, provides torque transmitted to an output shaft 514, functioning as an output member from which torque is further transferred to a pair of left and right drive wheels 40 via a differential gear device 516.

Further, the hybrid drive apparatus 510 includes a second motor/generator (hereinafter referred to as “MG2”) as a second drive power source (subsidiary drive power source) capable of selectively executing a power running control to allow drive power to be output for running the vehicle and a regenerative control for recovering energy. The MG2 is connected to the output shaft 514 via an automatic transmission 522. This allows a capacity of torque, transmitted from the MG2 to the output shaft 514, to be incremented or decremented depending on a speed ratio Rs (=rotation speed Nmg2 of MG2/rotation speed Nout of output shaft 514) that is set by the automatic transmission 522.

The automatic transmission 522 is formed in a structure that can establish plural gear positions each having a speed ratios Rs higher than “1”. During a power-running mode in which the MG2 generates torque, the MG2 provides increased torque that can be transferred to the output shaft 514, enabling the MG2 to be structured with a further reduced capacity or in a miniaturized size. With such a structure, if the rotation speed Nout of the output shaft 514 increases with, for instance an increase in vehicle speed, the MG2 is caused to operate at an operating efficiency sustained in a favorable state. To this end, the speed ratio Rs is reduced to cause a drop in the rotation speed Nmg2 of the MG2. In another case where a drop occurs in the rotation sped Nout of the output shaft 514, the speed ratio Rs is caused to increase to increase the rotation speed Nmg2 of the MG2.

During the operation of the automatic transmission 522 under a shifting state, a drop occurs in torque capacity of the automatic transmission 522 or inertia torque occurs due to a fluctuation in rotation speed, resulting in an impact on torque, i.e., output torque of the output shaft 514. Therefore, with the hybrid drive apparatus 510 described above, an operation is executed to control so as to compensate torque of the first drive-force source 512 during the shifting of the automatic transmission 522 for precluding or suppressing a fluctuation in torque of the output shaft 514.

The first drive-force source 512 is structured mainly of an engine 30, a first motor/generator (hereinafter referred to as “MG1”), and a planetary gear unit 526 provided for synthesizing or distributing torque between the engine 30 and the MG1. The engine 30 is a known internal combustion engine, such as a gasoline engine, and a diesel engine, etc., which is structured to have an electronic control device (E-ECU) 528 mainly composed of a microcomputer for performing engine control. The E-ECU 528 is arranged to electrically controlling operating states such as a the throttle opening degree, an air-intake volume, a fuel supply rate and ignition timing, etc. The electronic control device 528 is applied with detection signals from an accelerator depression-stroke sensor 52 operative to detect a depressed stroke of an accelerator pedal 50, and a brake switch 70 to detect the existence or nonexistence of a brake pedal 69 being depressed, etc.

The MG1, composed of, for example, a synchronous electric motor, is structured to selectively perform a function as an electric motor to generate drive torque and another function as an electric power generator. The MG1 is connected to an electricity storage device 532, such as a battery and a capacitor, etc., via an inverter 530. With a motor/generator-controlling electronic control device (MG-ECU) 534 mainly composed of a microcomputer to control the inverter 530, output torque or regenerative torque of the MG1 is adjusted or determined. The electronic control device 534 is supplied with a detection signal from a lever position sensor 74 arranged to detect a shift position of a shift lever 72, and the like.

The planetary gear unit 526 is a single-pinion type planetary gear mechanism operative to perform a known differential action and includes three rotary elements such as a sun gear S0, a ring gear R0 in concentrically meshing engagement with the sun gear S0, and a carrier C0 with which pinions P0 meshing with the sun gear S0 and the ring gear R0 are supported to rotate about their own axes and move around the sun gear S0. The planetary gear unit 526 is disposed to be concentric to the engine 30 and the automatic transmission 522. The planetary gear unit 526 and the automatic transmission 22 have nearly symmetric structures with respect a centerline and, hence, lower half parts thereof are herein omitted from FIG. 16.

With the present embodiment, the engine 30 has a crankshaft 536 connected to the carrier C0 of the planetary gear unit 526 via a damper 538. In contrast, the sun gear S0 is connected to the MG1 and the output shaft 14 is connected to the ring gear R0. The carrier C0 functions as an input element; the sun gear S0 functions as a reactive element; and the ring gear R0 functions as an output element.

With the planetary gear unit 526, if reactive torque of the MG1 is input to the sun gear S0 in contrast to output torque of the engine 30 to be input to the carrier C0, the ring gear R0, serving as the output element, bears torque higher than torque input from the engine 30. This causes the MG1 to function as the electric power generator. In addition, with the rotation speed of the ring gear R0, i.e., the rotation speed (output shaft rotation speed) Nout of the output shaft 514 remained constant, causing the rotation speed Nmg1 of the MG1 to fluctuate to be more or lower results in a capability of continuously (infinitely) varying the rotation speed (engine rotation sped) Ne of the engine 30. That is, the operation can be executed to perform a control such that the engine rotation speed Ne is set to, for example, a rotation speed optimum for fuel economy by controlling the MG1. This type of hybrid system is referred to as a mechanical distribution system or a split type.

Turning back to FIG. 16, the automatic transmission 522 of the present embodiment is comprised of one set of a Ravigneaux type planetary gear mechanism. That is, the automatic transmission 22 includes first and second sun gears S1 and S2. A large diameter portion of a stepped pinions P1 meshes with the first sun gear S1. A small diameter portion of the stepped pinions P1 meshes with pinions P2, which are held in meshing engagement with a ring gear R1 (R2) disposed in concentric relation to the sun gears S1 and S2. A common carrier C1 (C2) supports the pinions P1 and P2 as to rotate about their own axes and around the sun gears S1 and S2. Besides, the second sun gear S2 meshes with the pinion P2.

With the motor/generator-controlling electronic control device (MG-ECU) 534 operating to control the MG2 via the inverter 540, the MG2 is caused to operate as the electric motor or the electric power generator to regulate or determine assist output torque or regenerative torque. The MG2 is connected to the second sun gear S2 and the carrier C1 is connected to the output shaft 514. The first sun gear S1 and the ring gear R1 forms, in combination with the pinions P1 and P2, a mechanism equivalent to a double-pinion type planetary gear unit. Further, the second sun gear S2 and the ring gear R1 forms, in combination with the pinion P2, a mechanism equivalent to a single-pinion type planetary gear unit.

The automatic transmission 522 further includes: a first brake B1 disposed between the first sun gear S1 and a transmission housing 542 for the first sun gear S1 to be selectively fixed; and a second brake B2 disposed between the ring gear R1 and the transmission housing 42 for the ring gear R1 to be selectively fixed. These brakes B1, B2, acting as so-called friction engagement devices operative to generate braking forces due to friction forces, may include multi-plate type engagement devices or band-type engagement devices. Moreover, the brakes B1 and B2 are structured to continuously vary torque capacities depending on engaged pressures resulting from a brake-B1-actuating actuator B1A and a brake-B2-actuating actuator B2A such as hydraulic actuators or the like, respectively.

With the automatic transmission 522 of such a structure as described above, the second sun gear S2 functions as an input element and the carrier C1 functions as an output element. With the first brake B1 caused to engaged, a high-speed gear position H with a speed ratio Rsh higher than “1” is established. With the second brake B2 is caused to engage in place of the first brake B1, a low-speed gear position L with a speed ratio Rsl higher than the speed ratio Rsh of the high-speed gear position H is established. That is, the automatic transmission 522 has a second-stage transmission in which a shifting between the high-speed and low-speed gear positions H and L is executed based on a running condition of the vehicle such as a vehicle speed V and a demanded drive force (or an accelerator's depression-stroke Acc), etc. More particularly, gear position regions are pre-determined as a map (shifting diagram) to allow the automatic transmission 522 to be controlled to set either one of the gear positions depending on detected driving states. An electronic control device (T-ECU) 544 is provided and mainly includes a microcomputer for performing such a control.

The electronic control device 544 is supplied with detection signals from an AT oil temperature sensor 78 for detecting an AT oil temperature TEMP_{OIL} representing a temperature of hydraulic oil, a hydraulic switch SW1 for detecting an engagement hydraulic pressure of the first brake B1, and a hydraulic switch SW2 for detecting an engagement hydraulic pressure of the second brake B2, etc. The electronic control device 544 is further supplied with signals, representing relevant rotation speeds, from a MG2 rotation speed sensor 543 for detecting the rotation speed Nmg2 of the MG2, and an output-shaft rotation speed sensor 545 for detecting the output-shaft rotation speed Nout corresponding to the vehicle speed V. Moreover, the electronic control device 544 corresponds to a control device for a vehicular on/off control valve of the present invention.

With the automatic transmission 522 of such a structure set forth above, if the second brake B2 fixedly secure the ring gear R1, the low-speed gear position L is set and assist torque, output from the MG2, is amplified depending on the speed ratio Rsl with the moment to be additionally applied to the output shaft 514. Causing the first sun gear to be fixedly secured by the first brake B1 in place of the second brake B2 results in the setting of the high-speed gear position H having a speed ratio Rsh lower than the speed ratio Rsl of the low-speed gear position L. Since the speed ratio Rsh of the high-speed gear position H is higher than “1”, assist torque output by the MG2 is amplified in accordance with the speed ratio Rsh to be additionally applied to the output shaft 514.

Under circumstances where the respective gear positions L and H are routinely set, torque additionally applied to the output shaft 514 is equal to torque resulting from increasing output torque of the MG2 depending on the respective speed ratios. Under a shifting transition period of the automatic transmission 522, such torque is reflected on inertia torque occurring due to torque capacities of the brakes B1 and B2 and a fluctuation in rotation speed. In addition, torque additionally applied to the output shaft 514 takes positive torque during a driving state of the MG2 and negative torque during a non-driving state of the same. As used herein, the term “non-driving state of the MG2” refers to a state under which the rotation of the output shaft 514 is transferred through the automatic transmission 522 to the MG2 which in turn is drivably rotated and which does not necessarily involved in a driving or non-driving state of the vehicle 508.

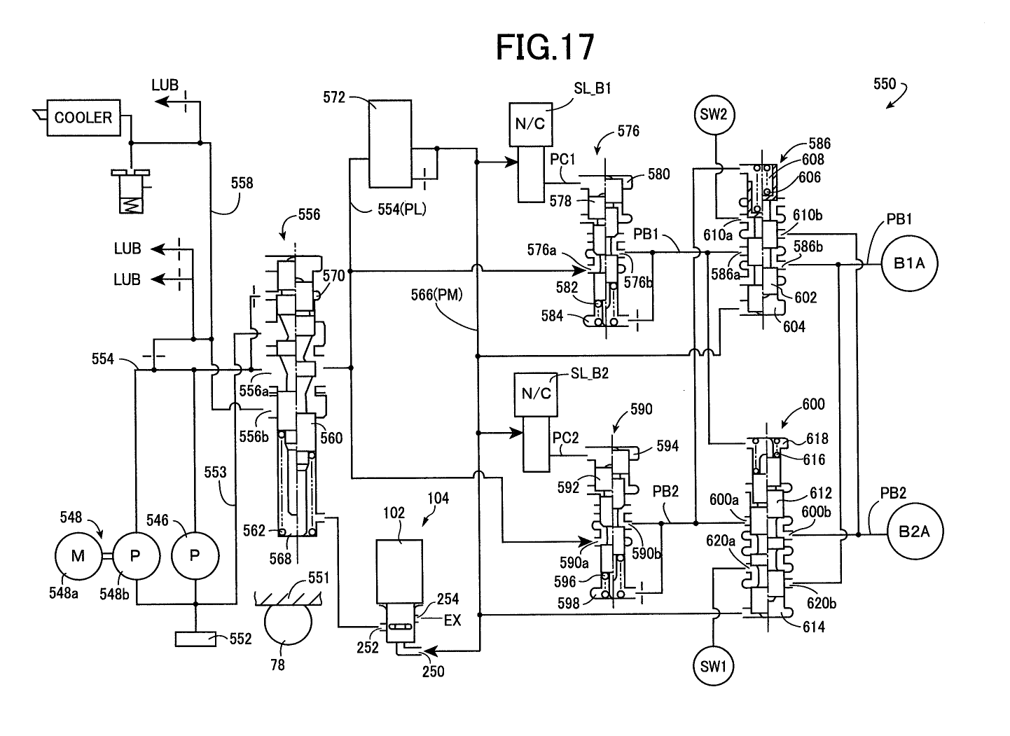

FIG. 17 shows a shifting hydraulic control circuit 550 (hereinafter referred to as “hydraulic control circuit 550”) for engaging or disengaging the brakes B1 and B2 to automatically control the shifting of the automatic transmission 522. The hydraulic control circuit 50 includes, as hydraulic pressure sources, a mechanical type hydraulic pump 546, operatively connected to a crankshaft 536 of the engine 30 to be rotatably driven by the engine 30, and an electric type hydraulic pump 548 composed of an electric motor 548a and a pump 548b rotatably driven by the electric motor 548a. The mechanical type hydraulic pump 546 and the electric type hydraulic pump 548 draw hydraulic oil, recirculated to an oil pan (not shown), via a strainer 552 or draw hydraulic oil, directly recirculated via a recirculation oil passageway 553, to be pumped to a line pressure hydraulic passageway 554. The AT oil temperature sensor 78, operative to detect the oil temperature TEMP_{OIL} of the recirculated hydraulic oil, is incorporated in a valve body 551 in which the hydraulic control circuit 550 is formed, but may be connected to a different site.

The switching electromagnetic solenoid valve 104 (see FIG. 5) has the input port 250 connected to a module-pressure hydraulic passageway 566 and the output port 252 connected to a control hydraulic chamber 568 of a line-pressure regulator valve 556. The switching electromagnetic solenoid valve 104 causes a hydraulic pressure of the control hydraulic chamber 568 to lie at a drain pressure under a non-electrically-magnetized state (turn-off state) while supplying a module pressure PM to the control hydraulic chamber 568 under an electrically-magnetized state (turn-on state).

Like the first embodiment, further, even with the hydraulic control circuit 550 of the present embodiment, the switching electromagnetic solenoid valve 296 (see FIG. 6) may be employed in place of the switching electromagnetic solenoid valve 104 set forth above. However, when using such a switching electromagnetic solenoid valve 296, like the first embodiment, the switching electromagnetic solenoid valve 296 is electrically-magnetized when attempting to have the hydraulic pressure of the control hydraulic chamber 568 as the drain pressure and not electrically-magnetized when attempting to supply the module pressure PM to the control hydraulic chamber 568.

A line-pressure regulator valve 556, acting as a relief-type pressure regulator valve, includes: a spool valve element 560 that opens and closes between a supply port 556a connected to the line-pressure oil passageway 554; and a discharge port 556b connected to a drain oil passageway 558. Further, the line-pressure regulator valve 556 includes: a control oil chamber 68, accommodating therein a spring 562 for applying a thrust to the spool valve element 560 in a direction to close the same while simultaneously receiving the module pressure PM delivered from a module-pressure oil passageway 566 via the switching electromagnetic solenoid valve 104 when altering a set pressure of the line pressure PL to a higher level; and a feedback oil chamber 570 connected to the line-pressure oil passageway 554 which applies a thrust to the spool valve element 560 in a direction to open the same. Such a structure allows one of a low pressure and a high pressure of two kinds to be output as a constant line pressure PL.

If a demanded output of a driver based on the accelerator's depression-stroke Acc is higher than a predetermined output determining value or if the automatic transmission 522 is placed under the shifting mode, i.e., during a shifting transition mode, then, the switching electromagnetic solenoid valve 104 is switched from a closed state (turn-off state) to an open state (turn-on state). As a result, the modulator pressure PM is supplied to the control oil chamber 568 to increase the thrust force, acting on the spool valve element 560 in the direction to close the same, by a given value such that the line pressure PL is switched from the low pressure state to the high pressure state.

Upon receipt of the line pressure PL as an original pressure, the module-pressure regulator valve 572 outputs a constant module pressure PM, set to be lower than the line pressure PL on a low-pressure side regardless of a fluctuation in the line pressure PL, which is delivered to the module-pressure oil passageway 566. A first linear solenoid valve SL_B1 for controlling the first brake B1 and a second linear solenoid valve SL_B2 for controlling the second brake B2 have valve characteristics of normally closed types (N/C) each of which remains non-current-supplied to place the input port and the output port in a valve-closed state (blocked state). Upon receipt of the module pressure PM as an original pressure, the first and second linear solenoid valve SL_B1 and SL_B2 output control pressures PC1 and PC2 depending on drive currents ISOL1 and ISOL2 representing command values delivered from the electronic control device 544. The resulting control pressures PC1 and PC2 are caused to increase with increases in, for instance, the drive currents ISOL1 and ISOL2.

A B1-control valve 576 includes: a spool valve element 578 for opening or closing a flow path between an input port 576a, connected to the line-pressure oil passageway 554, and an output port 576b that outputs a B1-engagement hydraulic pressure PB1; a control oil chamber 580 receiving a control pressure PC1 from the first linear solenoid valve SL_B1 in order to urge the spool valve element 78 in a opened-valve direction; and a feedback oil chamber 584 accommodating a spring 82 urging the spool valve element 578 in a closed-valve direction while receiving the B1-engagement hydraulic pressure PB1 that is the output pressure. Upon receipt of the line pressure PL as an original pressure, the B1-control valve 576 outputs the B1-engagement hydraulic pressure PB1 at a level depending on the control pressure PC1 delivered from the first linear solenoid valve SL_B1 to be supplied to the first brake B1 via a B1-apply control valve 586 that functions as an interlock valve.

A B2-control valve 590 includes: a spool valve element 592 that opens and closes a flow path between an input port 590a, connected to the line-pressure oil passageway 554, and an output port 590b that outputs a B2-engagement hydraulic pressure PB2; a control oil chamber 594 that receives the control pressure PC2 from the second linear solenoid valve SL_B2 in order to urge the spool valve element 592 in a opened-valve direction; and a feedback oil chamber 598 which accommodates therein a spring 596 that urges the spool valve element 592 in a closed-valve direction while receiving the B2-engagement hydraulic pressure PB2 that is the output pressure. Upon receipt of the line pressure PL in the line-pressure oil passageway 554 as an original pressure, the B2-control valve 590 outputs the B2-engagement hydraulic pressure PB2 at a level, depending on the control pressure PC2 delivered from the second linear solenoid valve SL_B2, which is delivered to the second brake B2 through a B2-apply control valve 600 that functions as an interlock valve.

A B1-apply control valve 586 includes a spool valve element 602 for opening or closing a flow path between an input port 586a, receiving the B1-engagement hydraulic pressure PB1 output from the B1-control valve 576, and an output port 586b connected to the first brake B1. The B1-apply control valve 586 further includes an oil chamber 604, receiving the module pressure PM for urging the spool valve element 602 in the closed-valve direction, and an oil chamber 608 accommodating therein a spring 606 for urging the spool valve element 602 in a closed-valve direction while receiving the B2-engagement hydraulic pressure PB2 output from the B2-control valve 590. The B1-apply control valve 586 is brought into an opened-valve state until the B2-engagement hydraulic pressure PB2 is supplied for engaging the second brake B2. Upon receipt of the B2-engagement hydraulic pressure PB2, the B1-apply control valve 86 is switched to a valve-closed state, thereby preventing the engagement of the first brake B1.

Further, the B1-apply control valve 586 includes a pair of ports 610a and 610b that are closed when the spool valve element 102 is paced in the opened-valve position (at a position on the right side of a centerline shown in FIG. 17), and that are opened when the spool valve element 102 is placed in the closed-valve position (at a position as indicated on the left side of the centerline shown in FIG. 4). A hydraulic switch SW2 is connected to one port 610a for detecting the B2-engagement hydraulic pressure PB2 and the second brake B2 is directly connected to the other port 610b. With the B2-engagement hydraulic pressure PB2 reaching a predetermined high-pressure state, the hydraulic switch SW2 assumes a switch-on. With the B2-engagement hydraulic pressure PB2 reaching a predetermined low-pressure state and lower, the hydraulic switch SW2 is switched to a switch-off state. The hydraulic switch SW2 is connected to the second brake B2 via the B1-apply control valve 86. This makes it possible to make a determination as to whether a failure is present in the B2-engagement hydraulic pressure PB2 or simultaneously whether failures exist in the first linear solenoid valve SL_B1, the B1-control valve 576 and the B1-apply control valve 586, etc., which constitute a hydraulic pressure system of the first brake B1.

Like the B1-apply control valve 586, the B2-apply control valve 600 also includes a spool valve element 612 that opens and closes a flow path between an input port 600a, receiving the B2-engagement hydraulic pressure PB2 output from the B2-control valve 590, and an output port 600b connected to the second brake B2. The B2-apply control valve 600 further includes an oil chamber 614, applied with the module pressure PM in order to urge the spool valve element 612 in the valve-opened direction, and an oil chamber 618 accommodating therein a spring 616 for urging the spool valve element 612 in the valve-closed direction while applied with the B1-engagement hydraulic pressure PB1 output from the B1-control valve 576. The B2-apply control valve 600 is caused to remain in a valve-opened state until the B2-apply control valve 60 is supplied with the B1-engagement hydraulic pressure PB1 for engaging the first brake B1. Upon receipt of the B1-engagement hydraulic pressure PB1, the B2-apply control valve 600 is switched to the valve-closed state, so that the engagement of the second brake B2 is prevented.

The B2-apply control valve 100 also includes a pair of ports 620a and 620b that are closed when the spool valve element 612 is placed in the valve-opened position (at a position as indicated on the right side of the centerline shown in FIG. 17) and that are opened when the spool valve element 112 is placed in the valve-closed position (at a position as indicated on the left side of the centerline shown in FIG. 17). The hydraulic switch SW1 is connected to one port 620a for detecting the B1-engagement hydraulic pressure PB1 and the first brake B1 is directly connected to the other port 620b. The hydraulic switch SW1 assumes a switch-on state when the B1-engagement hydraulic pressure PB1 reaches a predetermined high-pressure state and is switched to a switch-off state when the B1-engagement hydraulic pressure PB1 drops below a predetermined low-pressure state. The hydraulic switch SW1 is connected to the first brake B1 via the B2-apply control valve 600. This makes it possible to make a determination as to whether a failure is present in the B1-engagement hydraulic pressure PB or simultaneously whether failures exist in the second linear solenoid valve SL_B2, the B2-control valve 590 and the B2-apply control valve 600, etc., which constitute a hydraulic pressure system of the second brake B2.

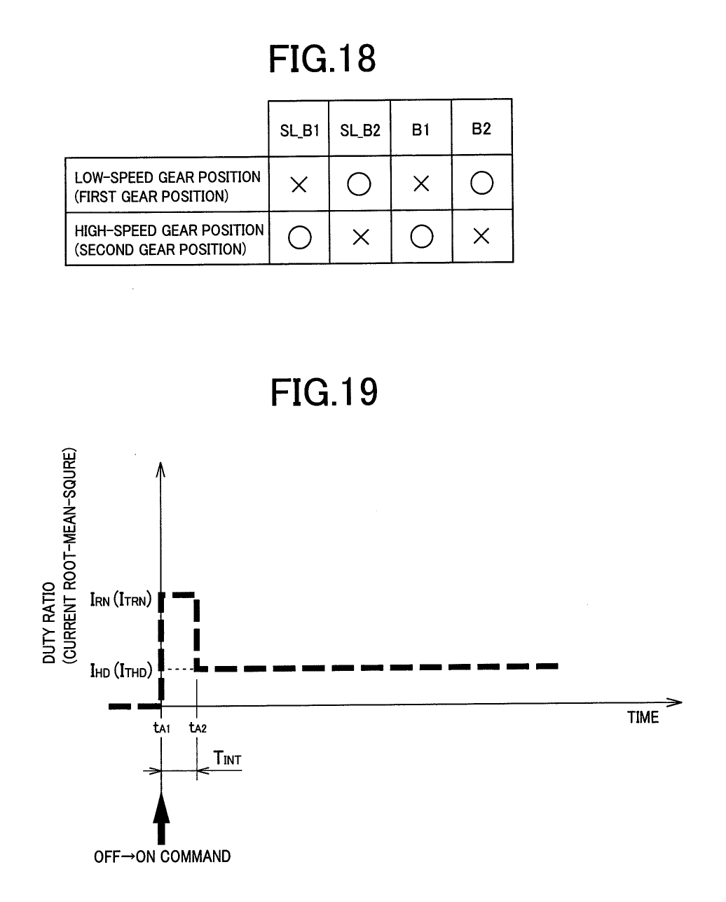

FIG. 7 is a table illustrating operations of the hydraulic control circuit 550 of such a structure as described above. In FIG. 18, a mark “∘” represents an electrically-magnetized state or an engaged state and a mark “x” represents a non-electrically-magnetized state or a disengaged state. That is, with the first linear solenoid valve SL_B1 being not electrically-magnetized and the second linear solenoid valve SL_B2 being electrically-magnetized, the first brake B1 is disengaged and the second brake B2 is engaged, thereby causing the automatic transmission 22 to establish the low-speed gear position L. In addition, with the first linear solenoid valve SL_B1 being electrically-magnetized and the second linear solenoid valve SL_B2 being not electrically-magnetized, the first brake B1 is engaged and the second brake B2 is disengaged, thereby causing the automatic transmission 22 to establish the high-speed gear position H.

The hybrid drive apparatus 510 executes a well-known hybrid running control. That is, after a key is inserted to a key slot, actuating a power switch with a brake pedal depressed in operation results in a startup of the control. Then, a demanded output of a driver is calculated based on the accelerator's depression-stroke Acc to allow the engine 30 and/or the MG2 to generate the demanded output such that the vehicle is driven with a lower amount of exhaust emissions at low fuel consumption. To this end, for instance, a motor running mode achieved mainly by the MG2 acting as the drive force source with the engine 30 rendered inoperative, a charged-power running mode causing the vehicle to run with the MG2 acting as the drive force source while the engine 30 provides a drive power to cause the MG1 to generate electric power, and an engine running mode causing the vehicle to run with the drive power of the engine 30 being mechanically transferred to the drive wheels 40 are switched depending on a running state.

With the engine 30 remained under the driving condition, further, the MG1 controls the engine rotation speed Ne such that the engine 30 operates on an optimum fuel economy curve. Furthermore, when the MG2 is driven to initiate torque assist, the automatic transmission 522 is set to the low-speed gear position L under a condition in which the vehicle speed is low causing increased torque to be applied to the output shaft 14. With an increase in the vehicle speed V, the automatic transmission 522 is set to the high-speed gear position H to relatively lower the rotation speed Nmg2 of the MG2 for achieving a reduction in loss, thereby causing torque assist to be executed with increased efficiency. During the shifting of the automatic transmission 522, for instance, the shifting of the automatic transmission 522 is determined based on the vehicle speed V and the accelerator's depression-stroke Acc or the like by referring to the pre-stored relationship (shifting diagram). Then, the first and second brakes B1 and B2 are controlled so as to switch a gear position determined based on such a determining result. During a coast running, moreover, the MG2 or the MG1 is rotatably driven in response to inertia energy of the vehicle 508 to regenerate electric power, which in turn is stored in the battery 532.

Even with the present embodiment, the control function is applied to the control of the switching electromagnetic solenoid valve 104 or the switching electromagnetic solenoid valve 296 by using the circuit shown in FIG. 7, thereby obtaining the same advantages as those of the first embodiment.

Especially, during the motor-running mode, almost no probability takes place the electric power to be charged to the battery 532 due the halt of the engine 30. Therefore, executing the solenoid control of the current control means 386 results in a reduction in waste current (see FIG. 8) to a lower value than tat achieved with the related art on/off control, thereby suppressing electric power consumption with a resultant increase in available running mileage of the MG2.

### Third Embodiment

The first embodiment has been set forth above with reference to a case in which the present invention is applied to the control device with a feedback control which is performed to control the sustaining current value I_{HD} (solenoid current value I_{RL}) so as to coincidence to the predetermined target operation initiating current value I_{TRN}. On the contrary, the third embodiment will be described below with reference to a case in which the present invention is applied to a control device with a feed-forward control which is performed to control the sustaining current value I_{HD} (solenoid current value I_{RL}) to approach the predetermined target operation initiating current value I_{TRN}.

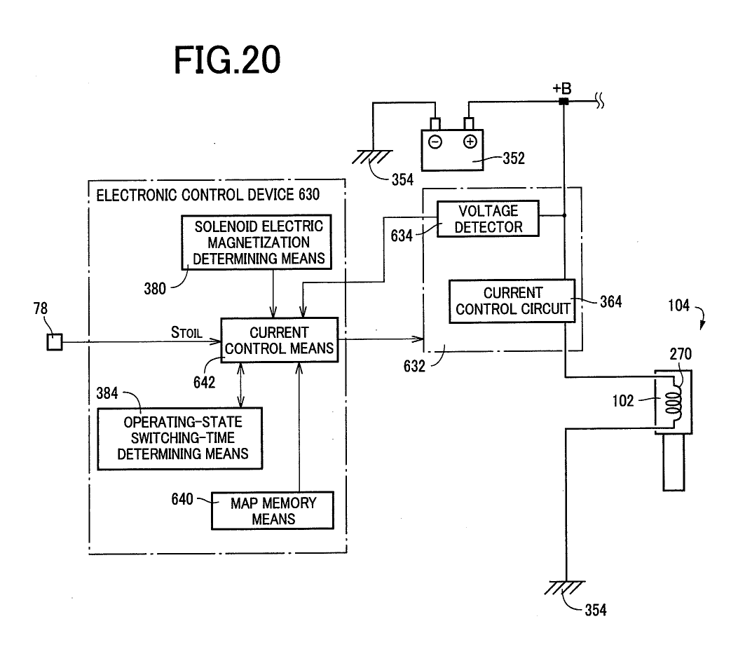

FIG. 20 is a schematic diagram, illustrating a major part of an electromagnetic valve driver circuit 632 for controlling the operation of the switching electromagnetic solenoid valve 104 corresponding to the on/off control valve of the present invention, which represents a functional block diagram for illustrating a major part of a control function incorporated in the electronic control device 630 to which the present invention is applied.

The electromagnetic valve driver circuit 632 of this embodiment corresponds to the electromagnetic valve driver circuit 350 of the first embodiment. The electromagnetic valve driver circuit 632 is constituted similar to the electromagnetic valve driver circuit 350 except that the electromagnetic valve driver circuit 632 has a voltage detector 634 for detecting a output-voltage of the battery 352 instead of the current detector 358. The current control circuit 364 of the electromagnetic valve driver circuit 632 has a switching element for controlling the drive current of the coil 270 by means of controlling a duty of current pulse applied to the coil 270. In this embodiment, the solenoid current I_{RL}, the operation initiating current value I_{RN}, and the sustaining current value I_{HD} are effective values of supplied current to the coil 270 except notice.

The voltage detector 634 detects a output-voltage of the battery 352 which functions as a power source of the electromagnetic solenoid valve 104, and outputs a signal indicating a source voltage V_{SOL} to the coil 270, since the output-voltage of the battery 352 coincides with the source voltage V_{SOL}.

The electronic control device 630 has a current control portion or means 642 instead of the current control means 386, and a map memory means 640.

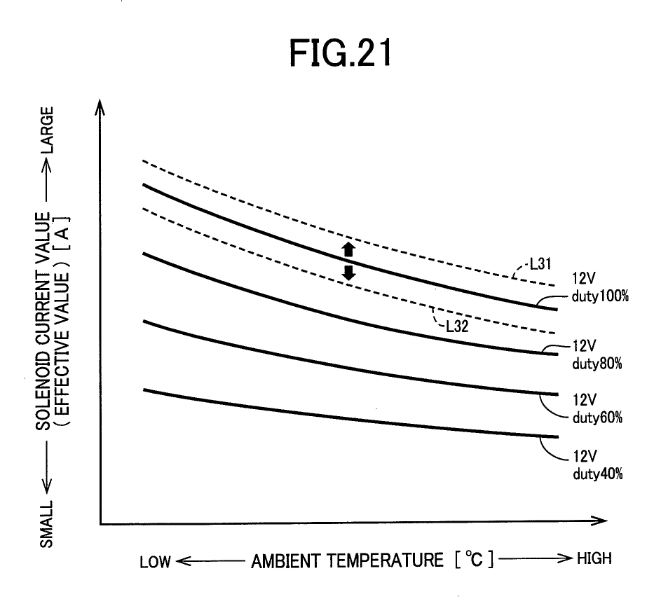

The map memory portion or means 640 memorizes a current-command map which is pre-set experimentally so as to match the sustaining current value I_{HD} with a predetermined target sustaining current value I_{THD}. The current-command map indicates a relationship between a duty ratio DTY of the sustaining current value I_{HD} supplying to the solenoid current value I_{RL}, an ambient temperature of the switching electromagnetic solenoid valve 104, and a source voltage V_{SOL} to the coil 270. The duty ratio DTY corresponds to the current-command determined based on the ambient temperature of the switching electromagnetic solenoid valve 104 and the source voltage V_{SOL} in view of the current-command map. The solenoid current I_{RL} of the coil 270 is affected by the ambient temperature of the switching electromagnetic solenoid valve 104 and the source voltage V_{SOL}. The solenoid current I_{RL} increases as the duty ratio DTY is larger. The FIG. 21 shows the relationship of these phenomena.

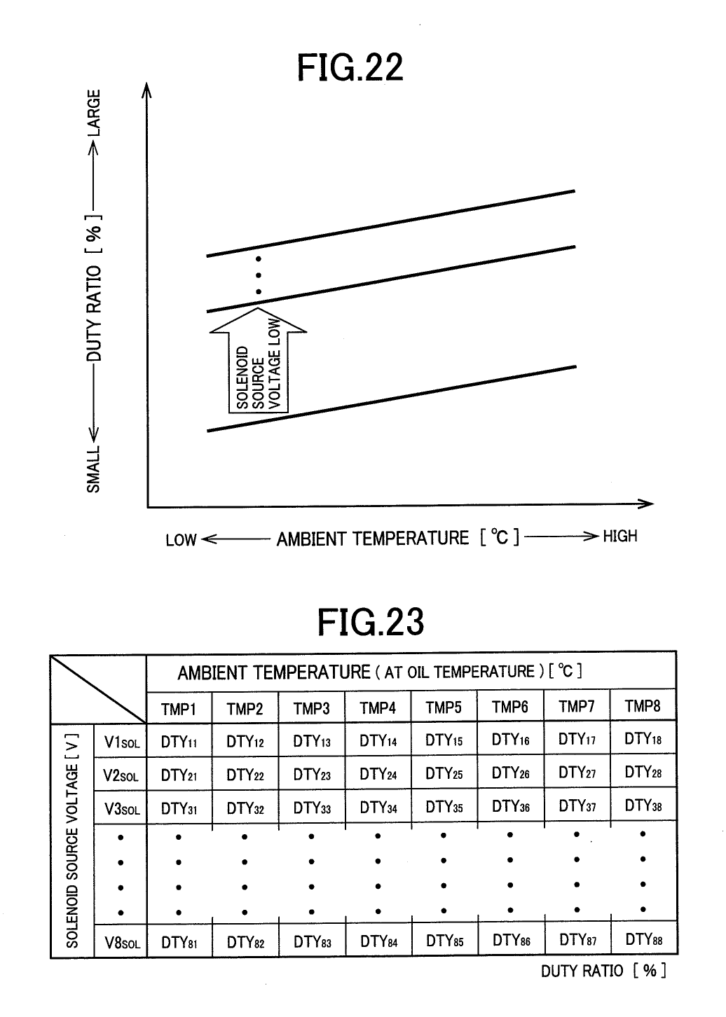

As the resistance of the coil 270 increases as the ambient temperature of the switching electromagnetic solenoid valve 104 goes to higher, the solenoid current I_{RL} of the coil 270 decreases with increasing of the ambient temperature as shown in FIG. 21. In FIG. 21, at around the 100% line of the duty ratio DTY, the solenoid current I_{RL} changes up and down in connection with high and low of the source voltage V_{SOL}, as shown in dot line L31 and L32. From these disposition of the solenoid current I_{RL} of the coil 270, the current-command map stored in the map memory means 640 is pre-determined experimentally so as to match the sustaining current value I_{HD} with a predetermined target sustaining current value I_{THD}, irrespective of the changes of the ambient temperature of the switching electromagnetic solenoid valve 104 and/or the source voltage V_{SOL}. As shown in FIG. 22, the relationship of the current-command map is determined that the duty ratio DTY increases in relation to increasing of the ambient temperature of the switching electromagnetic solenoid valve 104 and decreasing of the source voltage V_{SOL}. Although the current-command map may stored in the map memory means 640 as a diagram shown in FIG. 22, the current-command map in this embodiment consists of separated ambient temperature values TMP1˜TMP8 and separated source voltages V1_{SOL}˜V8_{SOL} as shown in FIG. 23. The target sustaining current value I_{THD} may be determined in a manner as same as that of the first embodiment. However, in this embodiment, since the sustaining current value I_{HD} is controlled by feed forward control, the current-command map and the target sustaining current value I_{THD} are determined to keep the on-state of the switching electromagnetic solenoid valve 104 with a sufficient margin in consideration of the various accuracy of parameters. For example, there are the increase the resistance value of the coil 270 operated, the differences of the resistance value and inductance value of the coil 270, the changes the resistance value of the coil 270 due to the ambient temperature.

The current control means 642 is constituted similar to the current control means 386 except that the sustaining current value I_{HD} is controlled by the feed forward control using the current-command map which is pre-set experimentally so as to match the sustaining current value I_{HD} with a predetermined target sustaining current value I_{THD}.

The feed forward control is as follows. The current control means 642 determine the duty ratio DTY based on the source voltage V_{SOL} detected by the voltage detector 634 and the ambient temperature of the switching electromagnetic solenoid valve 104 by referring to a pre-stored relationship of the current-command map stored in the map memory means 640. For example, the duty ratio DTY₃₆ is determined based on the source voltage V3_{SOL} and the ambient temperature TMP6 in view of the pre-stored relationship of the current-command map shown in FIG. 23. In this calculation, the intermediate values in FIG. 23 may be calculated from the source voltages V1_{SOL}˜V8_{SOL} or the ambient temperature TMP1˜TMP8 by means of a linear interpolation. The current control means 642 controls the current supplied to the switching electromagnetic solenoid valve 104 according to the duty ratio DTY. Thus, the current control means 642 continues the determination of the duty ratio DTY and executes the above feed forward control.

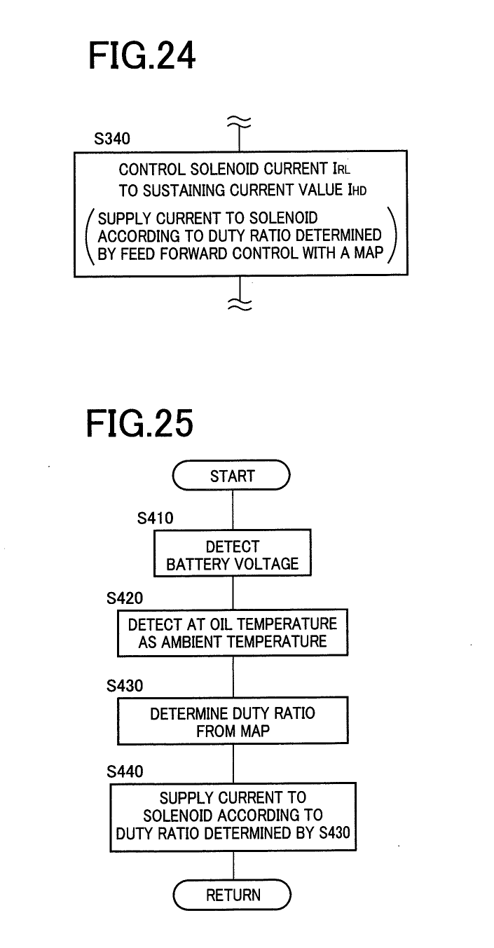

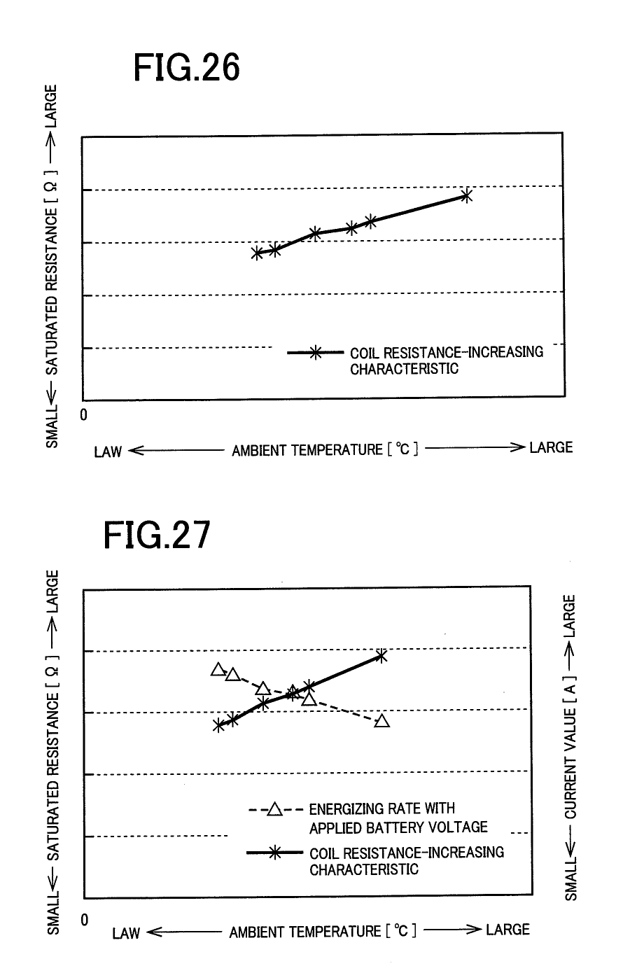

FIGS. 24 and 25 are a flow chart illustrating a major part of the feed forward control of the electronic control device 630. The flow chart of the electronic control device 630 is constituted similar to the flow chart of FIG. 14 except the step S340 shown in FIG. 24.

At the step S340 corresponding to the current control means 642, the current to the switching electromagnetic solenoid 102 of the switching electromagnetic solenoid valve 104 is controlled to the sustaining current value I_{HD} in accordance to the duty ratio DTY determined by the feed forward control utilized the current-command map stored in the in the map memory means 640. The feed forward control shown in the step S340 is executed repeatedly.

FIG. 25 is a flow chart illustrating a major part of the feed forward control i.e., the control operation for determining the duty ratio DTY so as to allow the sustaining current value I_{HD} to match the target sustaining current value I_{THD}. The steps of FIG. 25 are correspond to the current control means 642.

At the step S410 of FIG. 25, the source voltage V_{SOL} i.e., output voltage of the battery 352 is detected by the signal from voltage detector 634. At the step S420 of FIG. 25, the ambient temperature of the switching electromagnetic solenoid valve 104 i.e., AT oil temperature TEMP_{OIL} is detected by the AT oil temperature sensor 78.

At the step S430 of FIG. 25, the feed forward control is executed to determine the duty ratio DTY based on the source voltage V_{SOL} detected by the step S410 and the ambient temperature of the switching electromagnetic solenoid valve 104 detected by the step S420 referring to a pre-stored relationship of the current-command map stored in the map memory means 640, which is pre-set experimentally so as to allow the sustaining current value I_{HD} to match the target sustaining current value I_{THD}.

At the step S440 of FIG. 25, the current to the switching electromagnetic solenoid 102 of the switching electromagnetic solenoid valve 104 is controlled to the sustaining current value I_{HD} in accordance to the duty ratio DTY determined by the step S430.

The present embodiment has various advantages as same as the advantages (A1) to (A2) and (A4) to (A11) of the first embodiment. The current control means 642 determines the duty ratio DTY based on the source voltage V_{SOL} and the ambient temperature of the switching electromagnetic solenoid valve 104 referring to a pre-stored relationship of the current-command map stored in the map memory means 640, which is pre-set experimentally so as to allow the sustaining current value I_{HD} to match the target sustaining current value I_{THD}. As the current control means 642 controls the sustaining current value I_{HD} to match the target sustaining current value I_{THD} by means of the above feed forward control, the waste electric current is minimized to be lower than that achieved with the related art on/off control, minimizing power consumption of the switching electromagnetic solenoid valve 104, with a simple current control means compared to the first embodiment.

In the foregoing, although the present invention has been described above with reference the embodiments shown in the accompanying drawings, it is intended that the embodiments described be considered only as illustrative of the present invention and that those skilled in the art can implement the present invention in modes with various modifications and improvements.

For instance, while with the first and second embodiment described above, the current control element 362 shown in FIG. 7 has been composed of the transistor, the present invention is not limited thereto.

With the first to third embodiments discussed above, further, while the electromagnetic valve driver circuit 350, 632 is provided independently of the switching electromagnetic solenoid valve 104 in FIG. 7, a whole of or a part of the electromagnetic valve driver circuit 350, 632 may be incorporated in the switching electromagnetic solenoid valve 104. For instance, the current detecting element 360 may be incorporated in the switching electromagnetic solenoid valve 104 and a terminal for detecting the solenoid current I_{RL} may be incorporated in the switching electromagnetic solenoid valve 104.

With the first and second embodiments discussed above, furthermore, the electric-magnetization states of the switching electromagnetic solenoid valves 104 and 296 may be controlled on direct currents or may be subjected to duty controls. For instance, when performing the duty controls of the switching electromagnetic solenoid valves 104 and 296, the timing chart indicated by the broken line L01 in FIG. 8, is substituted as shown in FIG. 19 wherein a duty ratio or a current root-mean-square value is plotted on the ordinate axis. In addition, the various current values I_{RL}, I_{RN}, I_{HD}, I_{TRN} and I_{THD} are expressed in terms of duty ratios (in current root-mean-square value) depending on such current values, respectively.

With the first to third embodiments discussed above, moreover, the switching electromagnetic solenoid valve 104 takes a structure in which with the input port 250 remained in the closed state, the urging force is applied to the spherical valve element 262 in opposition to the supply pressure P_{M} applied to the input port 250 to sustain such a closed state. However, the present invention is not limited to such a structure provided that the electromagnetic valve controlled with the control device of the present invention, is an on/off valve of the type that is placed in an operating state switched between a turn-on state and a turn-off state depending on the electrically-magnetization or non-electrically-magnetizing of the solenoid. The switching electromagnetic solenoid valve 104 may include, for instance, an electromagnetic type directional control valve having a spool valve element formed with a communication recess for establishing a communicating state or a non-communicating state between respective ports or a two-way valve.

While with the first and second embodiment shown in FIG. 7, the current controller 356, the coil 270 and the current detector 358 are connected in series, the electromagnetic drive circuit 350 is not particularly limited to such a structure. It doesn't matter if such component parts are connected in a structure different from that of FIG. 7. With the third embodiment, the electromagnetic valve driver circuit 632 shown in FIG. 20 is also not particularly limited to such a structure.

While with the first and second embodiment shown in FIG. 8, further, the switching electromagnetic solenoids 102 and 298 are magnetized to cause the switching electromagnetic solenoid valves 104 and 296 to be placed in the operating state switched to the turn-on state after which the solenoid current value I_{RL} is caused to match the sustaining current value I_{HD} at a lower level than that present at the beginning of the magnetization. However, no operation may be executed to decrease the solenoid current value I_{RL} and the current control is performed to enable the turn-off state to be switched to the turn-on state while setting a fixed current value to be as small as possible.

While with the flow chart for the first and second embodiment shown in FIG. 14, furthermore, the feedback control is executed at S140. However, it is conceived that no such a feedback control is executed. For instance, the solenoid control may be executed to allow the sustaining current value I_{HD} to be decreased with respect to the operation initiating current value I_{RN} at a given rate without executing the feedback control for the sustaining current value I_{HD}.

While at S150 of the first and second embodiment shown in FIG. 14, the solenoid current value I_{RL} (solenoid current value I_{RL}) is controlled so as to lie at the target operation initiating current value I_{TRN}, the solenoid current value I_{RL} may be controlled in the same feedback control as that executed for the sustaining current value I_{HD}. In the third embodiment, as the electromagnetic valve driver circuit 632 is simplified due to the feed forward control, the initiating current value I_{RN} may be controlled in the same feed forward control as that executed for the sustaining current value I_{HD}.

With the first and second embodiments described above, if the control current value I_{CON} is set to allow the maximum current to supply through the current control element 362 until the initial current-supplying time T_{INT} elapses from the solenoid electrically-magnetizing command such that the operation initiating current value I_{RN} is uniquely determined based on resistance values of the coils 270 and 322 and a predetermined coil applied voltage applied to the coils 270 and 322. In such a case, the coil applied voltage is determined on experimental tests so as to obtain the operation initiating current value I_{RN} to enable the turn-off state to be switched to the turn-on state even under a circumstance where the resistance values of the coils 270 and 322 are maximized depending on usage states.

Further, while the first embodiment has been described above with reference to a case where the present invention is applied to the normal engine-propelled vehicle and the second embodiment has been described above with reference to a case in which the present invention is applied to the hybrid vehicle, the structure of the vehicle is not particularly limited and the present invention may be applicable to, for instance, an electric vehicle.

Furthermore, it can be also conceived that the present invention is applicable to control the on/off control valve incorporated in the hydraulic pressure control circuit for performing a shifting control of a CVT.

With the first to third embodiments mentioned above, moreover, the switching electromagnetic solenoid valves 104 and 296 are employed in the hydraulic control circuits 100 and 550 of the automatic transmissions 10 and 522, respectively, usages of those valves are not limited to those for hydraulic pressure controls of the automatic transmissions 10 and 522.

With the first and second embodiments mentioned above, besides, the current control means 386 determines the initial current-supplying time T_{INT} based on the AT oil temperature TEMP_{OIL} and determines the operation initiating current value I_{RN} (the target operation initiating current value I_{TRN}) based on the supply pressure P_{M} applied to the switching electromagnetic solenoid valve 104. However, the operation initiating current value I_{RN} (the target operation initiating current value I_{TRN}) may be determined based on the AT oil temperature TEMP_{OIL} and the initial current-supplying time T_{INT} may be determined based on the supply pressure P_{M}. In such a case, the current control means 386 executes a control such that the lower the AT oil temperature TEMP_{OIL}, the higher will be the operation initiating current value I_{RN} (the target operation initiating current value I_{TRN}). In addition, the control is executed such that the higher the supply pressure P_{M}, the longer will be the initial current-supplying time T_{INT}.

With the first and second embodiments mentioned above, the current control means 386 may be arranged to determine the initial current-supplying time T_{INT} and the operation initiating current value I_{RN} (the target operation initiating current value I_{TRN}) based on both of the AT oil temperature TEMP_{OIL} and on the supply pressure P_{M} applied to the switching electromagnetic solenoid valve 104. In an alternative, the initial current-supplying time T_{INT} and the operation initiating current value I_{RN} (the target operation initiating current value I_{TRN}) may be determined based on either one of the AT oil temperature TEMP_{OIL} and the supply pressure P_{M} applied to the switching electromagnetic solenoid valve 104. In addition, the relationship between the AT oil temperature TEMP_{OIL}, the initial current-supplying time T_{INT} and the operation initiating current value I_{RN} (the target operation initiating current value I_{TRN}) has no need to be continuous and such a relationship may vary in a stepwise relationship in the order of, for instance, about a two-stage or a three-stage.

With the first to third embodiments mentioned above, additionally, although the initial current-supplying time T_{INT} and the operation initiating current value I_{RN} (the target operation initiating current value I_{TRN}) are determined based on both of the AT oil temperature TEMP_{OIL} and the supply pressure P_{M}, it doesn't matter if the initial current-supplying time T_{INT} and the operation initiating current value I_{RN} (the target operation initiating current value I_{TRN}) are pre-determined to lie at, for instance, a fixed value with no regard to the AT oil temperature TEMP_{OIL} or the supply pressure P_{M}.

While FIG. 8 related to the first to third embodiment described above, represents that the operation initiating current value I_{RN} and the sustaining current value I_{HD} do not vary in accordance with an elapse of time, it is to be appreciated that such a relationship is typically illustrated for a better understanding and it doesn't matter if both of the factors vary in accordance with an elapse of time.

Moreover, during the solenoid control of the first to third embodiment set forth above, the solenoid current value I_{RL} drops from the operation initiating current value I_{RN} to the sustaining current value I_{HD} due to the elapse of the initial current-supplying time T_{INT}. The elapse of such a time is not essential to be a criteria for the drop in the solenoid current value I_{RL}. For instance, positions of the plungers 264 and 314 may be detected to provide plunger positions, based on which the operation may be executed to lower the solenoid current value I_{RL} from the operation initiating current value I_{RN} to the sustaining current value I_{HD}.

With the third embodiments mentioned above, the duty ratio DTY of the sustaining current value I_{HD} (solenoid current value I_{RL}) is used as the current-command of the sustaining current of the switching electromagnetic solenoid valve 104, however, it doesn't matter if other parameter is used as the current-command of the sustaining current of the switching electromagnetic solenoid valve 104.

With the first to third embodiments mentioned above, at least two of the three embodiments may be combined each other.

Besides, although no individual illustrations are made, the present invention may be implemented in various modifications without departing from the scope of the present invention.

1. A control device for a vehicular on/off control valve used in a hydraulic control circuit of a vehicle for switching an operating state of the on/off control valve between a turn-on sate or a turn-off state on electrically-magnetizing or non-electrically-magnetizing a solenoid incorporated in the on/off control valve,
the control device being operable to set a current value current-supplied to the solenoid in an operation initiating current value needed for initially switching the on/off control valve from the turn-off state to the turn-on state during an electrically-magnetized state of the solenoid, and in a sustaining current value lower than the operation initiating current value and needed for sustaining the turn-on state after switched to the turn-on state.

2. The control device for the vehicular on/off control valve according to claim 1, wherein a feedback control is performed to match the sustaining current value with a predetermined target sustaining current value.

3.-9. (canceled)

10. The control device for the vehicular on/off control valve according to claim 1, wherein the current value to be current-supplied to the solenoid is set in the operation initiating current value, until a predetermined initial current-supplying time elapses from issuance of a command for switching the on/off control valve from the turn-off state to the turn-on state, and in the sustaining current value after a lapse of the initial current-supplying time.

11. The control device for the vehicular on/off control valve according to claim 2, wherein the current value to be current-supplied to the solenoid is set in the operation initiating current value, until a predetermined initial current-supplying time elapses from issuance of a command for switching the on/off control valve from the turn-off state to the turn-on state, and in the sustaining current value after a lapse of the initial current-supplying time.

12. The control device for the vehicular on/off control valve according to claim 1, wherein the initial current-supplying time is determined based on a temperature of a hydraulic oil supplied to the on/off control valve by referring to a pre-stored relationship.

13. The control device for the vehicular on/off control valve according to claim 2, wherein the initial current-supplying time is determined based on a temperature of a hydraulic oil supplied to the on/off control valve by referring to a pre-stored relationship.

14. The control device for the vehicular on/off control valve according to claim 10, wherein the initial current-supplying time is determined based on a temperature of a hydraulic oil supplied to the on/off control valve by referring to a pre-stored relationship.

15. The control device for the vehicular on/off control valve according to claim 11, wherein the initial current-supplying time is determined based on a temperature of a hydraulic oil supplied to the on/off control valve by referring to a pre-stored relationship.

16. The control device for the vehicular on/off control valve according to claim 12, wherein the initial current-supplying time is determined to be longer as temperature of the hydraulic oil becomes lower.

17. The control device for the vehicular on/off control valve according to claim 13, wherein the initial current-supplying time is determined to be longer as temperature of the hydraulic oil becomes lower.

18. The control device for the vehicular on/off control valve according to claim 14, wherein the initial current-supplying time is determined to be longer as temperature of the hydraulic oil becomes lower.

19. The control device for the vehicular on/off control valve according to claim 15, wherein the initial current-supplying time is determined to be longer as temperature of the hydraulic oil becomes lower.

20. The control device for the vehicular on/off control valve according to claim 1, wherein the operation initiating current value is determined based on a pressure of the hydraulic oil supplied to the on/off control valve by referring to a pre-stored relationship.

21. The control device for the vehicular on/off control valve according to claim 2, wherein the operation initiating current value is determined based on a pressure of the hydraulic oil supplied to the on/off control valve by referring to a pre-stored relationship.

22. The control device for the vehicular on/off control valve according to claim 10, wherein the operation initiating current value is determined based on a pressure of the hydraulic oil supplied to the on/off control valve by referring to a pre-stored relationship.

23. The control device for the vehicular on/off control valve according to claim 11, wherein the operation initiating current value is determined based on a pressure of the hydraulic oil supplied to the on/off control valve by referring to a pre-stored relationship.

24. The control device for the vehicular on/off control valve according to claim 12, wherein the operation initiating current value is determined based on a pressure of the hydraulic oil supplied to the on/off control valve by referring to a pre-stored relationship.

25. The control device for the vehicular on/off control valve according to claim 20, wherein the on/off control valve includes an input port to which the hydraulic oil is supplied, an output port, and a valve element actuated by the solenoid, the valve element being operative to allow the input port and the output port to communicate with each other upon current-supplying of the solenoid, and to close the input port upon non-current-supplying of the solenoid, and the operation initiating current value being determined to be low as the pressure of the hydraulic oil becomes higher.

26. The control device for the vehicular on/off control valve according to claim 20, wherein the on/off control valve includes an input port to which the hydraulic oil is supplied, an output port, and a valve element actuated by the solenoid, the valve element being operative to close the input port upon current-supplying of the solenoid, and to allow the input port and the output port to communicate with each other upon non-current-supplying of the solenoid, and the operation initiating current value being determined to be higher as the pressure of hydraulic oil becomes higher.

27. The control device for the vehicular on/off control valve according to claim 1, wherein a feed forward control is performed in which the sustaining current value is determined based on a output voltage of a power source and the ambient temperature of the on/off control valve by referring to a pre-stored relationship decided so as to match the sustaining current value with a predetermined target sustaining current value.
